(19) United States
(12) Patent Application Publication
(10) Pub. No.: US 2014/0163896 A1
(43) Pub. Date: Jun. 12, 2014

(54) HIV INCIDENCE ASSAYS WITH HIGH SENSITIVITY AND SPECIFICITY

(71) Applicant: Ha Youn Lee, San Marino, CA (US)

(72) Inventor: Ha Youn Lee, San Marino, CA (US)

(73) Assignee: UNIVERSITY OF ROCHESTER, Rochester, NY (US)

(21) Appl. No.: 14/126,777

(22) PCT Filed: Aug. 25, 2011
(86) PCT No.: PCT/US2011/049154

§ 371 Date: Dec. 16, 2013

Related U.S. Application Data
(60) Provisional application No. 61/497,783, filed on Jun. 16, 2011.

(51) Int. Cl. G06F 19/18

(52) U.S. Cl. CPC G06F 19/18
USPC 702/19

(57) ABSTRACT

The invention provides methods for manipulating the distribution of HIV gene sequences from a subject infected with HIV to classify whether the subject has been infected for more or less than a year. The Methods are useful, for example, in determining whether prophylactic interventions such as vaccines or drug candidates are slowing the rate of transmission in a population.

### CROSS-REFERENCE TO RELATED APPLICATIONS

This application claims the benefit of U.S. Provisional Application No. 61/497,783, filed Jun. 16, 2011, the contents of which are incorporated herein by reference.

### STATEMENT OF FEDERAL FUNDING

This invention was made with government support under Grant No. RO1 AI083115 awarded by the National Institute of Allergy and Infectious Diseases of the National Institutes of Health. The government has certain rights in the invention.

### PARTIES TO A JOINT RESEARCH AGREEMENT

Not applicable.

### REFERENCE TO SEQUENCE LISTING OR TABLE SUBMITTED ON COMPACT DISC AND INCORPORATION-BY-REFERENCE OF THE MATERIAL

Not applicable.

### BACKGROUND OF THE INVENTION

Assessing how many people have been recently infected with HIV-1 in a given area is an important task in HIV/AIDS prevention (Brookmeyer, R., 253: 37-42 (1991)). Accurate estimates of HIV incidence are important in permitting public health agencies, non-Governmental organizations, and other entities concerned with HIV/AIDS treatment and prevention to allocate properly HIV-related health care resources. Accurately distinguishing recent, or “incident,” infections from chronic infections enables public health officers and practitioners to monitor epidemics, evaluate the impact of antiretroviral treatment, and assess the efficacy of HIV prevention trials, including modalities such as vaccination (Burton et al., Nat Immunol 5: 233-236 (2004)), microbicides (McGowan, I., Biologicals 34: 241-255 (2006)), and other types of interventions (Auvert et al., PLoS Med 2: e298 (2005)).

The approximate window period of HIV incident infections is the first year post transmission, which covers the eclipse phase and the stages of the Fiebig classification based on the orderly appearance of viral RNA, viral antigens such as p24 and p31, and HIV-specific antibodies (Fiebig et al. AIDS 17: 1871-1879 (2003)). This period is characterized by a rapid expansion and decline of viral RNA and the gradual increase of HIV-1-specific antibody titers (FIG. 1A). Current HIV incidence assays are based on the idea that antibody level or avidity rise in a predictable pattern during the first 4 to 6 months post transmission, eventually reaching a plateau that stays roughly constant for many years (FIG. 1A). Assays based on this pattern include the Serologic Testing Algorithm for Recent HIV-1 Seroconversion (STARHS) (Janssen et al., J Amer Med Assn 280:42-48 (1998); Kothe et al., J Acquir Immune Defic Syndr 33: 625-634 (2003)), the BED capture enzyme immunoassay (BED) (Hargrove et al., AIDS 22: 511-518 (2008), and the guanidine-based antibody avidity assay (Chawla et al., J Clin Microbiol 45: 415-420 (2007); Thomas et al., Clin Exp Immunol 103: 185-191 (1996)). Serologic assays based on this pattern, however, have a number of critical limitations, including difficulties in standardization, difficulties in reproducibility, and a strong dependence on the infecting virus clade (Chawla, supra; Busch et al., AIDS 24: 2763-2771 (2010)). These limitations result in notable inaccuracy; for instance, the sensitivity (proportion of incident infections correctly identified as incident) varies in the range of 42% and 100% with median of 89%, across 13 serologic assays (Guy et al., Lancet Infect Dis, 9:747-59 (2009)). The specificity (the proportion of chronic infections correctly identified as chronic), ranges from 49.5% to 100% with a median of 86.8%. The tendency to misclassify long-standing infections as recent is pronounced among patients on anti-retroviral treatment (Guy, supra); this substantial rate of false reports of chronic infections as being recent infections is a significant limitation of serologic assays and results in overestimating the number of incident infections.

It would be desirable to have an assay permitting distinguishing between incident and chronic infections that reduces the rate of false reports and which accurately distinguishes recent from chronic HIV infections. The present invention satisfies these and other goals.

### BRIEF SUMMARY OF THE INVENTION

The invention provides robust new methods for classifying a subject's HIV infection as being incident or chronic.

In a first group of embodiments, the invention provides methods of determining with a high degree of sensitivity and specificity whether a subject infected with human immunodeficiency virus-1 (“HIV-1”) having a gene (an “env gene”) encoding an envelope polypeptide has a chronic infection, the methods comprising: (a) obtaining a nucleic acid sequence of the env gene from each of a plurality of HIV-1 virions from the subject, each sequence being (i) of at least about 500 contiguous bases, (ii) having at least about 500 contiguous bases from the same genomic location in the gene as the other sequences, and (iii) aligned so that said at least about 500 contiguous bases of (a)(ii) are in the same position within their respective sequences, (b) counting, for each sequence relative to each of the other sequences, the number of instances in which the nucleic acid bases at the same position do not match, thereby generating a Hamming distance (“HD”) for each sequence relative to each of the other sequences, (c) determining a HD distribution from the HD of each sequence relative to each of the other sequences, and, (d) calculating from the HD distribution a 10% quantile, “Q₁₀”, by determining the HD value which divides the HD distribution into 10% below that HD value and 90% above that HD value, wherein, when the nucleic acid sequence in step (a) (iii) is about 500 bases in length and said Q₁₀ value is higher than 0, the infection is a chronic infection, when the nucleic acid sequence in step (a) (iii) is about 1000 bases in length and said Q₁₀ value is higher than 1, the infection is a chronic infection, when the nucleic acid sequence in step (a) (iii) is about 2000 bases in length and said Q₁₀ value is higher than 2, the infection is a chronic infection, and when the nucleic acid sequence in step (a) (iii) is about the full length of the env gene and the Q₁₀ value is higher than 7, the infection is a chronic infection, thereby determining with a high degree of sensitivity and specificity whether the subject has an incident infection. In some embodiments, the sequences of nucleic acid bases of the env gene in step 1(a)(i) are from 30 or more HIV-1 virions from the subject. In some embodiments, the sequences of nucleic acid bases of the env gene in step 1(a)(i) are from 500 or more or 1000 or more HIV-1 virions from the subject. In some embodiments, the aligned contiguous bases of step (a) (iii) are of about 1000 bases of the env gene. In some embodiments, the aligned contiguous bases of step (a) (iii) are of about 2000 bases of the env gene. In some embodiments, the aligned contiguous bases of step (a) (iii) are of about the entire length of the env gene.

In a second group of embodiments, the invention provides methods for determining with a high degree of sensitivity and specificity whether a subject infected with human immunodeficiency virus-1 (“HIV-1”) having a gene (an “env gene”) encoding an envelope polypeptide has an incident infection, said method comprising: (a) obtaining a nucleic acid sequence of the env gene from each of a plurality of HIV-1 virions from the subject, each sequence being (i) of at least about 500 contiguous bases and (ii) having at least about 500 contiguous bases from the same genomic location in the gene as the other sequences, and (iii) aligned so that said at least about 500 contiguous bases of (a)(ii) are in the same position within their respective sequences, (b) counting, for each sequence relative to each of the other sequences, the number of instances in which the nucleic acid bases at the same position do not match, thereby generating a Hamming distance (“HD”) for each sequence relative to each of the other sequences, (c) determining a HD distribution from the HD of each sequence relative to each of the other sequences, and, (d) calculating from said HD distribution a 10% quantile, “Q₁₀”, by determining the HD value which divides the HD distribution into 10% below that HD value and 90% above that HD value, wherein, when said nucleic acid sequence in step (a) (iii) is about 500 bases in length and the Q₁₀ value is 0, and the subject does not have a clinical symptom of AIDS, the infection is an incident infection, when the nucleic acid sequence in step (a) (iii) is about 1000 bases in length and the Q₁₀ value is 1 or lower and the subject does not have a clinical symptom of AIDS, the infection is an incident infection, when the nucleic acid sequence in step (a) (iii) is about 2000 bases in length and said Q₁₀ value is 2 or lower and the subject does not have a clinical symptom of AIDS, the infection is an incident infection, and when the nucleic acid sequence in step (a) (iii) is about the full length of the env gene and said Q₁₀ value is lower than 7 and the subject does not have a clinical symptom of AIDS, the infection is an incident infection, thereby determining with a high degree of sensitivity and specificity whether the subject has an incident infection. In some embodiments, the clinical symptom of AIDS is a CD₄+ T cell count of 200 CD4+ T cells or less per microliter. In some embodiments, the sequences of nucleic acid bases of said env gene in step 1(a)(i) are from 20 or more HIV-1 virions from the subject. In some embodiments, the sequences of nucleic acid bases of the env gene in step 1(a)(i) are from 1000 or more HIV-1 virions from the subject. In some embodiments, the aligned contiguous bases of step (a) (iii) are of about 1000 bases of the env gene. In some embodiments, the aligned contiguous bases of step (a) (iii) are of about 2000 bases of the env gene. In some embodiments, the aligned contiguous bases of step (a) (iii) are of about the entire length of the env gene.

In yet another group of embodiments, the invention provides methods of determining with a high degree of sensitivity and specificity whether an individual infected with human immunodeficiency virus (“HIV”) has an incident infection or a chronic infection, the methods comprising: (a) obtaining sequences of nucleic acid bases of a selected HIV gene from a plurality of HIV virions from said individual, (b) aligning the sequences of nucleic acid bases of the selected HIV gene so that the bases have positions within their respective sequences comparable to the positions of the bases in the other sequences, (c) comparing the nucleic acid base in each position in one sequence to the nucleic acid base at the same position in each of the other sequences and counting the number of instances in which the nucleic acid bases at the same position in each sequence pair do not match, thereby generating Hamming distances (“HDs”) for each sequence relative to each of the other sequences, (d) creating a HD distribution from the HDs generated in step (c), (e) calculating from the HD distribution a selected quantile, “Qₓ”, wherein “Qₓ” is an integer from 1 to 20, to obtain a HD value which divides the HD distribution into x % below it and (100-x) % above it, (f) selecting a value at which sensitivity and specificity are maximized, thereby selecting a cut-off value C, (g) comparing the HD value of step (e) to the cutoff value C of step (f) to obtain a result, R, wherein a result R above the cut-off value C indicates the infection is a chronic infection. In some embodiments, the result R at or below the cut-off value C and the absence of a clinical symptom of AIDS indicates that the infection is an incident infection. In some embodiments, the clinical symptom of AIDS is a CD₄+ T cell count of 200 CD₄+ T cells or less per microliter.

In some embodiments, x is an integer between 1 and 25. In some embodiments, x is an integer between 1 and 15. In some embodiments, x is 10. In some embodiments, the sequences of nucleic acid bases of a selected HIV gene from the plurality of HIV viruses from the subject are from 50 or more HIV virions from the subject. In some embodiments, the sequences of nucleic acid bases of a selected HIV gene from the plurality of HIV virions from the subject are from 1,000 or more HIV viruses from the subject. In some embodiments, the HIV is HIV-1. In some embodiments, the HIV-1 gene is selected from the group consisting of env, pol, nef, and gag. In some embodiments, the HIV-1 gene is env. In some embodiments, the nucleic acid sequences are about 500 nucleotide bases in length. In some embodiments, the nucleic acid sequences about 1000 nucleotide bases in length. In some embodiments, the nucleic acid sequences are about the length of the selected HIV gene.

In a further group of embodiments, the invention provides methods of determining whether an individual infected with a human immunodeficiency virus (“HIV”) has an incident infection, a chronic infection, or a late stage chronic infection, the methods comprising: (a) obtaining sequences of nucleic acid bases of a selected HIV gene from a plurality of HIV virions in the individual, (b) aligning the sequences of nucleic acid bases of the selected HIV gene to permit comparing nucleic acid bases present at the same positions in each sequence, (c) comparing the nucleic acid base in each position in each sequence to the nucleic acid base at the same position in each of the other sequences, (d) counting the number of instances in which the nucleic acid bases at the same position in each of the sequences do not match the base at the same position in each of the other sequences, thereby generating Hamming distances (“HDs”) for the respective sequences, (e) creating a HD distribution from the HD of the respective sequences, and, (f) calculating from the HD distribution a selected quantile, “Qₓ”, wherein x is an integer from 1 to 25, to obtain a HD value which divides the HD distribution into x % below it and (100-x %) above it, (g) determining a value at which the sensitivity and specificity are maximized, thereby selecting a cutoff value C, (h) comparing said HD value of step (f) to the cutoff value C and determining if the HD value is the same as, higher than, or lower than, said cutoff value C, and (i) determining whether the subject has clinical symptoms of AIDS, wherein: when the HD value of step (f) is higher than the cutoff value C, said subject has a chronic HIV infection, when the subject has one or more clinical symptoms of AIDS, the subject has a late stage chronic infection regardless of said HD value, and when the HD value of step (f) is equal to or lower than the cutoff value C and the subject does not have one or more clinical symptoms of AIDS, the subject has an incident infection. In some embodiments, the one or more clinical symptom of AIDS is a low CD₄+ T cell count. In some embodiments, the low CD₄ count is a count of less than 200 CD₄+ T cells per microliter. In some embodiments, x is an integer between 1 and 20. In some embodiments, x is an integer between 1 and 10. In some embodiments, x is 10. In some embodiments, the HIV is HIV-1. In some embodiments, the sequences of nucleic acid bases of a selected HIV gene from the plurality of HIV virions from the individual are from 50 or more HIV virions from the individual. In some embodiments, the sequences of nucleic acid bases of a selected HIV gene from the plurality of HIV virions from the individual are from 1,000 or more HIV virions from the individual. In some embodiments, the HIV gene is selected from the group consisting of env, pol, nef, and gag. In some embodiments, the HIV gene is env. In some embodiments, the HIV is HIV-1. In some embodiments, the nucleic acid sequences are about 500 nucleotide bases in length. In some embodiments, the nucleic acid sequences about 1000 nucleotide bases in length. In some embodiments, the nucleic acid sequences about 2000 nucleotide bases in length. In some embodiments, the nucleic acid sequences are about the length of the selected HIV gene.

In yet another group of embodiments, the invention provides methods of determining a cutoff value for use in distinguishing, with a high degree of sensitivity and specificity, incident infections of human immunodeficiency virus (“HIV”) from a chronic infection, the methods comprising: (a) obtaining sequences of nucleic acid bases of a selected HIV gene from a plurality of HIV virions from samples from a plurality of individuals known or determined to have incident or chronic HIV infections at the time the samples were taken, keeping track of which sequences are from persons classified as having an incident infection and which sequences are from persons classified as having chronic infections, (b) for each sample, aligning the sequences of nucleic acid bases of the selected HIV gene to permit comparing nucleic acid bases present at the same positions in each sequence, (c) for each sample, comparing the nucleic acid base in each position in each sequence to the nucleic acid base at the same position in each of the other sequences, (d) for each sample, counting the number of instances in which the nucleic acid bases at the same position in each of the sequences do not match the base at the same position in each of the other sequences, thereby generating Hamming distances (“HDs”) for the respective sequences, (e) for each sample, creating a HD distribution from the HD of the respective sequences for the sample, thereby creating a plurality of HD distributions, (f) calculating for each of the plurality of HD distributions a selected quantile, “Qₓ”, wherein x is an integer from 1 to 25, to obtain a HD value which divides the HD distributions into x % below it and (100-x %) above it, to create a plurality of Qₓ values, which Qₓ values have a distribution, (g) determining from the distribution of Qₓ values a value at which the sensitivity and specificity are maximized, thereby selecting said cutoff value C. In some embodiments, x is an integer between 1 and 10. In some embodiments, x is 10. In some embodiments, the HIV is HIV-1.

### BRIEF DESCRIPTION OF THE DRAWINGS

FIGS. 1A-B. FIG. 1A. FIG. 1A is a graph showing typical plots of viral load (dotted line) and antibody titer (solid line) following HIV-1 transmission. The vertical line at 12 months divides infections considered to incident (defined as the first year of infection) from those considered to be chronic (infections after the first year). FIG. 1B. FIG. 1B presents schematic representations of HIV-1 genomic populations at viral transmission, incident stage, and chronic stage. The horizontal row labeled “Single Founder” represents a typical diversification pattern when an infection originates from a single founder; the second row, labeled “Multiple Founders,” represents a typical pattern when an infection starts from three founder strains.

FIGS. 2A-B. FIG. 2A. FIG. 2A is a graph showing the env diversity of 102 acutely infected subjects with a single strain infection of HIV-1, 80 acutely infected subjects with multiple strain transmission, and 43 chronically infected subjects. FIG. 2B. FIG. 2B is a graph showing the env variance in the same groups of subjects as set forth in the same positions in FIG. 2A. In both Figures, the horizontal black line in each group of subjects denotes the median of that group and, in both panels, the black boxes plot the first and third quartiles for each group of subjects.

FIGS. 3A-C. FIG. 3A. FIG. 3A presents four graphs showing the HD distribution of the sampled sequences from two patients with incident HIV-1 infections, ACT54869022 in Bar et al., J Virol., 84:6241-6247 (2010) (top left) and 703010228 in Abrahams et al., J Virol., 83:3556-3567 (2009) (top right) and two subjects with chronic HIV-1 infections in Keele et al., Proc Natl Acad Sci USA 105: 7552-7557 (2008), SMRE4166 (bottom left) and SHKE4761 (bottom right). The vertical dashed line in each graph indicates the position of the computed 10% quantile, or Q₁₀, of the Hamming distances for each subject. (The vertical line in the graph in the upper right of FIG. 3A is too close to the axis to be visible in this plot except where it extends above the box.) FIG. 3B. The solid line in FIG. 3B is a graph of the distribution of the statistic Q₁₀ for the sequenced samples of 182 incident infections, shown as a smoothed approximation. The horizontal dotted line shows the smoothed estimate of the distribution of Q₁₀ calculated from 43 samples from subjects with chronic infections. (The vertical dotted line shows the Q₁₀ cutoff value.) The incident Q₁₀ distribution includes both 102 single and 80 multiple founder infections. FIG. 3C. FIG. 3C shows the computed ROC curve for the binary classification test based on the incident and chronic Q₁₀ distributions presented in FIG. 3B.

FIGS. 4A-D. FIG. 4A. FIG. 4A is a graph showing the dependence of the ROC curve on the subtype of HIV-1 infection. The dotted line represents the original ROC curve with the samples from both subtype B and C infections. The solid line represents the ROC curve when 69 incident samples with subtype C infections are excluded. FIG. 4B. FIG. 4B is a scatter plot of Q₁₀ and viral load measured from HIV-1 incident (black dot) and chronic (hollow dot) subjects. FIG. 4C. FIG. 4C is a graph showing the dependence of the Q₁₀ distribution on the length of the gene portion used. The three overlapping solid lines on the left denote the Q₁₀ distributions for the env genes of 182 HIV-1 incident infections determined using sequence lengths of the env gene of 500, 1000, and 2000 bases, respectively. These three lines are indistinct as the distributions are very close to each other. The three dotted lines represent the Q₁₀ distributions for the env genes of 43 chronic infections determined using nucleic acid base sequence lengths (“N_{B}”) of the gene 500, 1000, and 2000 bases, respectively, as labeled. FIG. 4D. FIG. 4D is a graph showing the dependence of the Q₁₀ distribution on the location of 500 base long env segments. For 43 chronic samples, the Q₁₀ distribution is shown by dotted lines; the segment of env gene HXB2 7125-7624 showed the greatest mean of Q₁₀ and the segment of HXB2 7625-8124 showed the smallest mean of Q₁₀. The two overlapping solid lines denote Q₁₀ distributions of the 182 incident samples at these two regions and are visually indistinct as the incident Q₁₀ distributions of the two regions are extremely close to one another.

FIGS. 5A-B. FIG. 5A. FIG. 5A is a graph showing the optimal cut-off value for the 10% quantile, Q₁₀^{cut-off}, of the binary classification test for each length and placement of the HIV-1 viral segments. The starting position of each segment is referenced to the genome of the HXB2 strain. As the portion of the envelope gene sequenced is shortened from 2000 bases to 1000 bases to 500 bases, the cut-off value decreases. FIG. 5B. FIG. 5B is a graph showing the sensitivity (+ symbol) and specificity (asterisk or star symbol) of the binary classification test for each viral segment.

### DETAILED DESCRIPTION

### Introduction

Determining whether new interventions are reducing transmission of HIV in human populations is a pressing public health need. The ability to make these determinations, however, has been frustrated by the difficulty in determining whether HIV infections found in members of the population are recent (a year or less old) or chronic (more than a year old). These difficulties stem in part from the manner in which HIV is transmitted in the human population, combined with the virus's rapid rate of mutation in its hosts. As noted in the Background section, serological tests have suffered from a number of drawbacks, such as a dependence on infecting clade and a fairly high percentage of false reports.

Surprisingly, the present invention provides methods that permit distinguishing incident (recent) infections from chronic ones with a high degree of sensitivity and specificity. For HIV-1, the two types of infections can be distinguished from chronic infections by the characteristics of the tail distribution of the mutations present in copies of the env gene in a single sample from a subject. Further surprisingly, the assays of the present invention permit the practitioner to make such distinctions even if the infection is a recent multi-variant transmission. Moreover, in the studies underlying the invention, the inventive assays were accurate regardless of the particular viral clade or clades with which the subject was infected. The inventive assays also provide methods for which the tail distribution of other genes can be used to make the same determinations for HIV-1 and for HIV-2. The inventive assays therefore provide robust new methods by which to differentiate incident from chronic HIV infections.

The inventive assays provide public health agencies, non-governmental organizations, and clinical practitioners with new, cost-effective tools to analyze HIV infections in individuals and in a population of individuals of interest. The inventive assays can assist, for example, in determining whether a vaccine candidate has provided individuals vaccinated with the vaccine candidate any protection from infection, whether proposed prophylactic agents have any protective effect, or whether new treatment regimens are effective in reducing HIV transmission in a population, a city, or a geographic area. In the case of a trial of a vaccine or of a potential prophylactic agent, the information provided by the inventive assays may indicate that the vaccine or agent has reduced the rate of HIV incidence in a community, and is therefore effective, or has not reduced the rate of incidence, and therefore is ineffective. Public health agencies and other entities can review the profile of incidence rates across geographic regions to assess the efficacy of HIV prevention or intervention trials. The inventive assays therefore provide not only a considerable advance over the techniques previously available in the art, but are also a valuable addition to the tools available to public health agencies, non-governmental organizations, and others involved in designing HIV prevention and intervention strategies to determine the efficacy of interventions against HIV and AIDS.

The studies underlying the invention used as an exemplar HIV gene the HIV-1 env gene and portions of that gene. As set forth in the Examples, env sequences from persons identified as having incident or as having chronic HIV-1 infections were examined and used to develop the inventive assays, which can determine with a high degree of sensitivity and specificity from manipulating information derived from env gene sequences from a subject whether that subject has a chronic HIV-1 infection or, in the absence of clinical symptoms of AIDS, has an incident infection. Thus, in some preferred embodiments, the inventive assays use HIV-1 env gene sequences or sequences of a portion of the gene from a subject to classify that subject's infection as being incident or chronic.

The inventive methods can also employ HIV genes other than env or portions thereof. Based on the results of the studies herein, it is expected that manipulating information derived from a subject's HIV gene sequences other than env can likewise be used to classify that subject as having a chronic or an incident infection. Further, the invention permits the use of sequences from persons classified as having incident or chronic infections to be used to provide accurate cutoff values for classifying whether a subject not already classified as incident or chronic can be so classified.

Finally, as discussed further herein, the methods of the invention utilize information derived from comparing hundreds, more usually thousands, and, in many embodiments, hundreds of thousands, of sequences. This information is then manipulated and processed to derive distributions and then cutoff values that permit determining whether an infection is chronic or incident. Accordingly, practice of the methods of the invention requires the use of computer processors provided with instructions to perform the steps described in this disclosure.

### DEFINITIONS

Units, prefixes, and symbols are denoted in their Systeme International de Unites (SI) accepted form. Numeric ranges are inclusive of the numbers defining the range. Unless otherwise indicated, nucleic acids are written left to right in 5′ to 3′ orientation. Nucleic acid bases are referred to using standard single letter codes. The headings provided herein are not limitations of the various aspects or embodiments of the invention, which can be had by reference to the specification as a whole. Accordingly, the terms defined immediately below are more fully defined by reference to the specification in its entirety.

Unless otherwise specified or required by context, as used herein, the terms “human immunodeficiency virus” and “HIV” as used herein refer to human immunodeficiency virus type 1 (“HIV-1”).

25 [0027] “Virion” refers to an individual virus particle. The term typically refers to the extracellular, infectious form of the virus. A blood sample from an individual infected with HIV-1 or HIV-2 will typically contain multiple virions of that virus, which may also be referred to as a “plurality” of virions.

“About”, in connection with the length of a nucleic acid sequence, means plus or minus 20 bases.

Unless otherwise stated or required by context, the term “sample” refers to blood or a body fluid containing HIV virions obtained from a subject infected with HIV.

As used herein, the terms “incident” infection and “recent” infection refer to a subject who acquired a HIV infection within a year of the time a sample was obtained from that subject. As used herein, the terms “recent” and “incident” in reference to an HIV infection are used interchangeably.”

As used herein, a “chronic” infection refers to a subject who acquired a HIV infection twelve months or more before the sample under analysis was obtained from that subject. As defined herein, persons with incident infections become classified as having chronic infections a year after their initial infection.

Persons of skill will appreciate that while a blood draw or other sample from a subject may be analyzed immediately after the sample is obtained, in some cases the blood or other sample may be preserved and stored for days, months, or years before the sample is analyzed. The terms “recent” and “incident,” however, classify the subject with respect to how long the subject was infected with HIV before the sample was taken, not when it is analyzed.

It is understood that persons practicing the inventive methods can either obtain sequences of HIV genes that have been sequenced by others and, for example, published in the literature in aligned or unaligned forms, or may take patient samples and sequence the genes of HIV virions present in the sample. For the sake of concision, the language “obtaining a nucleic acid sequence . . . aligned so that said at least about 500 contiguous bases of (a)(ii) are in the same position within their respective sequences,” is used herein to refer to either of these means by which the practitioner obtains sequences to subject, as if each was separately written out.

As used herein, “sensitivity” refers to the proportion of incident infections correctly identified as incident.

As used herein, “specificity” refers to the proportion of chronic infections correctly identified as chronic.

A “Hamming distance” (abbreviated “HD”) measures the number of positions at which the symbols in two strings of equal length are different. A “Hamming distance” therefore describes the number of substitutions needed to change one string into the other, and is a measure of the number of mismatches between the two.

The nucleotides comprising a nucleic acid sequence will sometimes herein be referred to interchangeably as “bases” for convenience of reference.

Genes have a length that can be defined by the starting and ending nucleotides of the coding sequence. For example, the env gene that encodes the envelope polyprotein of the HIV-1 reference strain HBX2CG (GenBank accession number K03455), is shown in GenBank to extend from nucleotide 6225 to 8795 of the genomic sequence of the virus. The full coding sequence of the gene, sometimes may be referred to herein as the full length of the gene.

A sample from a subject infected with HIV-1 or HIV-2 will typically contain multiple virions of that virus. Each of those virions has a genome containing the various viral genes, and sequencing a particular gene from some or all of the virions present in the sample will result in sequences of that gene equal in number to the number of virions from which the gene was sequenced. Thus, for example, if 50 virions are present in a sample from a subject and the env gene of each of those virions is sequenced, that will result in 50 separate nucleic acid sequences of the env gene, while if 1,000 virions are present in the sample and the env gene present in each virion is sequenced, there will be 1,000 separate nucleic acid sequences of the env gene from the 1,000 separate virions. The fact that the presence of multiple virions in a sample which will result in an number of nucleic acid sequences of a selected gene is what is intended to be conveyed by the phrase “obtaining a nucleic acid sequence [of a gene] from each of a plurality of . . . virions from said subject.”

As used herein, a gene “segment” or “portion” refers to a sequence of contiguous bases of a gene, which sequence is shorter than that of the full length gene. For example, a gene segment or portion may be 500, 1000, or 2000 contiguous nucleic acids in length. Since a gene such as the HIV-1 env gene is over 2500 bases in length, a segment of 500 contiguous bases could originate from many different positions within the length of the gene, such as the first 500 bases (e.g., starting at position 6225 of the genomic sequence of HIV-1 HBXCG, which can also be considered the first base of the env gene sequence) the middle 500 bases, or the last 500 bases, none of which would overlap with the other two. For the inventive assays, it is desirable that, if sequences shorter than the full length of the gene are used, the sequences be of at least about 500 contiguous bases and that the at least about 500 contiguous bases are from the same portion of the gene (e.g., that the at least 500 contiguous bases start at, for example, the nucleotide corresponding to position 6225 of the genomic sequence of HIV-1 HBX2CG) to permit comparison of the bases in each sequence to the bases in the same position in the other sequences as they occupy in the sequence of the reference virus (e.g., HIV-1 HBX2CG). This is the meaning intended by the phrase “having at least about 500 contiguous bases from the same genomic location in the gene as the other sequences”.

Contiguous bases within a viral gene's nucleic acid sequence can be said to have a “position” within the sequence. The position can be unambiguously referred to, for example, by providing the position the base occupies in the genomic sequence of the virus or by the numeric position the base occupies within the sequence of the gene itself or of the sequence itself. Thus, if one has a sequence of the first 500 bases of the HIV-1 HBX2CG env gene, which starts at position 6225 of the genomic sequence of HIV-1 HBX2CG, the position 10 bases in from the start can be referred to by its position in the overall genomic sequence of the virus, or by its position 10 places in from the starting nucleotide, both of which will be equivalent. If this sequence is then aligned with, for example, the first 500 bases of each of 9 other env sequences that all start from the base at position 6225 of the genomic sequence of HIV-1 HBX2CG, each base of each sequence will occupy a position that corresponds to the base at the same position of the other sequences, and these bases can then be compared to determine if they are the same or different. This is what is intended to be conveyed by the phrase “aligned so that at least about 500 contiguous bases . . . are in the same position within their respective sequences.”

If a numeric term is included in addition to the length of the segment or portion, it refers to the position within the sequence of the HIV-1 or HIV-2 complete genomic sequence from which the particular segment starts. For example, if a gene segment is stated to be 1000 bases long (HBX2 6860), it refers 1000 bases of the gene present in the HBX2 genomic sequence, where the 1000 base portion commences which the base at position 6860 of the genomic sequence of the reference viral strain HBX2 and continues from that point.

The exemplar gene used in the studies underlying the invention was the HIV-1 env gene. Accordingly, references herein to env without further identification refer to the HIV-1 env gene unless otherwise specified or required by context.

### Human Immunodeficiency Virus

Human immunodeficiency virus, or “HIV”, is a retrovirus of the lentivirus family. Two types of HIV are known, HIV-1 and HIV-2. HIV-1 is the causative agent of the great majority of HIV infections worldwide, while infections by HIV-2 are generally localized in West Africa. References herein to “HIV” will therefore refer to HIV-1 unless reference to HIV-2 is specified or it is clear reference to both viruses is intended or otherwise required by context. Because of the structural and family relationships between HIV-1 and HIV-2, it is believed that the assays described herein can also distinguish recent infections of HIV-2 from chronic infections of HIV-2. In preferred embodiments, the HIV type assayed by the inventive methods is HIV-1.

HIV-1 is classified as comprising several groups, which have uneven geographic distributions. These groups are Group M, Group N (non-M, non-O), Group O, and Group P. Group M, for “Major,” is the group responsible for some 90% of HIV/AIDS infections, particularly outside of limited areas of Africa. In some preferred embodiments, the HIV-1 virus is of Group M.

Group M is further classified as being subdivided into at least nine genetically distinct clades, or subtypes, identified by letters. These clades are identified by the letters A, B, C, D, F, G, H, J and K. Some researchers consider some of these clades, particularly A and F as having sub-subtypes, such as A1 and A2. The subtypes or clades tend to have uneven geographic distribution, but are useful for organizing viruses by genetic similarity. The studies underlying the invention indicate that the inventive methods are effective regardless of the infecting clade. In some preferred embodiments, the Group M clade is clade B. In other embodiments, the Group M clade is clade C. In other embodiments, the Group M clade is A1, A2, D, F1, F2, G, H, J or K. In still other embodiments, the subject's infection comprises viruses of different clades or includes a recombinant of parental viruses originating from 2 or more Group M clades.

While HIV-1 and -2 are different viruses, they have similar genome maps. Both have a gag gene, which codes for the viral capsid proteins, a pol gene, which codes for reverse transcriptase, an env gene coding for envelope-associated proteins, and the regulatory genes tat, rev, nef, vif and vpr. HIV-1 further has the regulatory gene vpu, while HIV-2 does not have vpu, but has a further regulatory gene vpx. HIV-2's clades are A, B, C, D, E, F and G (for HIV-2, the clades are considered “groups” rather than “subtypes” since they are more similar to the extent of the differences between the HIV-1 groups than they are to the extent of the differences between HIV-1 group subtypes).

Sequences for both HIV-1 and HIV-2 are published in annual compendia by the Los Alamos National Laboratory (“LANL”), the latest of which is currently Kuiken, C., et al., (eds.) HIV Sequence Compendium 2010, Theoretical Biology and Biophysics Group, Los Alamos National Laboratory, NM, LA-UR 10-03684. The compendia can be downloaded directly from the LANL website. LANL also maintains an HIV sequence database on the internet, which can be accessed by entering the following terms into a web browser as a single string: “hiv.” followed by “lanl.” followed by “gov.” (The terms are separated here to avoid forming an active hyperlink in on-line forms of this disclosure.)

Gene sequences from HIV-1 virions present in a sample can be aligned using as a reference strain HIV-1 HXB2 (GenBank accession number K03455; in GenBank this strain is referred to as “HXB2CG” for “HXB2 complete genome” and in the Los Alamos HIV database as “HXB2R” due to slight revisions from the original HBX2 sequence published in Wong-Staal et al., Nature 313:277-284 (1985)). For HIV-2, sequences from virions present in a sample can be aligned using the HIV-2 BEN isolate (GenBank Accession No. M30502) as the reference sequence.

### Sequences and Sequencing

The methods of the invention employ analyzing sequences of a selected gene of HIV present in a sample from a subject. In preferred methods, the sample is a blood draw from the subject. In some embodiments, the methods can be practiced using samples of other body fluids, such as semen or saliva, so long as they contain enough virions, at least 20 and preferably 50 or more, to permit building a Hamming distance distribution, as discussed further below.

As persons of skill will appreciate, a sample from an individual infected with HIV will typically comprise multiple HIV virions. Sequencing a selected gene or a segment thereof in a number of virions in the sample will therefore result in a corresponding number of sequences for the selected gene or gene sequence. For example, if the gene selected is the env gene, the practitioner may obtain sequences for the env gene from 50, from more than 500, from more than 1000, or from more than 5000 different virions present in a blood sample from a single infected individual.

Persons of skill will appreciate that it may be convenient to select a segment of a particular gene for amplification and analysis rather than the entire gene. As is well known in the art, genes and segments of genes are usually amplified by using primers that act to select either the gene or the selected portion of the gene the practitioner wishes to amplify and sequence, and methods and factors in designing appropriate primers to amplify the selected gene or portions thereof are well known to persons of skill in the art, as exemplified by, e.g., Yuryev, A. (ed.), PCR Primer Design, Humana Press (New York, 2010); Apte and Daniel, “PCR Primer Design” in Dieffenbach and Dveksler, eds., PCR Primer: A Laboratory Manual, Cold Spring Laboratory Press, 2^{nd} Ed. (Woodbury, N.Y., 2003); van Pelt-Verkuil et al., Principles and Technical Aspects of PCR Amplification, Springer Science+Business Media B.V. (Dordrecht, the Netherlands, 2010); and McPherson and Moller, PCR, Taylor and Francis Group, 2^{nd} Ed. (New York, 2006). The particular primers used to amplify the selected gene or portion thereof are not critical to the practice of the invention.

Preferably, the sequences are a minimum of about 500 contiguous nucleic acid bases of the selected HIV gene in length, with sequences longer than 500 bases being preferred, such as, in order of increasing preference, about 750 bases, about 1000 bases, or of about 2000 bases. In some preferred embodiments, the sequences are of the entire gene. As persons of skill will appreciate, the use of primers or other common amplification techniques will typically result in amplification of the same portion of the gene, but for the sake of clarity, it is noted that, where the sequencing is of a portion of the gene rather than of the whole gene, the portion of the gene sequenced should be the same portion for each sequence; that is, if the portion sequenced for one virion is of the first 1000 bases of the gene reading in the 5′ to 3′ direction, then the portion of the gene sequenced for other virions should also be of at least the first 1000 bases of the same gene when read in the same direction.

Current single genome amplification and sequencing techniques conventionally result in the sampling of 100 sequences or less, while so-called “deep sequencing” may provide 10,000 sequences from a single blood sample. Deep sequencing currently results in shorter sequence “reads,” typically of about 500 bases, than does single genome amplification. It is anticipated that, as deep sequencing techniques improve, they will provide longer sequence reads. While sequence “reads” longer than 500 bases can provide higher sensitivity and specificity when used in the methods of the invention, studies reported in the Examples demonstrate that satisfactory results can be obtained using sequence reads as short as 500 bases. In some embodiments, the sequence reads are about 1000 bases in length, while in other embodiments, the sequence reads are about 2000 bases in length. In other embodiments, the sequence reads are of the entire length of the selected gene. The methods by which the sequences of the gene or gene segment are obtained is not critical to the practice of the present invention. The sequences may indeed be obtained and provided to the practitioner prior to analysis by the inventive methods.

The practice of the invention relies on obtaining sequences of the selected HIV gene or gene segment from a plurality of virions present in a sample from a subject (such as in a blood sample from the subject). In preferred embodiments, the inventive methods employ at least 30 sequences of the same gene or gene segment (that is, the sequence of the gene or selected segment of the gene as found in at least 30 different virions in the sample taken from the subject). In other embodiments, the inventive methods employ at least 50 sequences of the same gene or segment of a gene. In other embodiments, the inventive methods employ at least 75 sequences of the same gene or segment of a gene. In some embodiments, the methods employ 100 sequences of the same gene or segment of a gene, and in some preferred embodiments, employ more than 100 sequences of the same gene or segment of a gene, such as 200, 500, 1000, or 5000 sequences.

HIV-1 is a double stranded RNA virus containing nine genes: env, gag, pol, tat, rev, nef, vif, vpr, and vpu. Based on the studies underlying the present invention, it is believed that any of these genes can be used in the assays of the invention, with vpr and vpu being less preferred. In some preferred embodiments, the gene or segment thereof used in the assay is env, gag, pol or nef. In some preferred embodiments, the gene or segment thereof used in the assay is env, gag, or pol. In preferred embodiments, the gene or segment thereof is env. For HIV-2, the same genes can be used (except, of course, for vpu, which is not present in HIV-2), with the same preferences as to the particular genes employed. The HIV-2 regulatory gene vpx is also less preferred.

Persons of skill will appreciate that both the cost of sequencing technology and the time required for sequencing have dropped markedly over the past decade and are continuing to drop. These advances make it more likely that sequence information regarding genes or portions thereof of virions present in a subject may be available before a public health agency or other party interested in differentiating incident from chronic infections decides to subject those sequences to the inventive methods. Additionally, the inventive assays can be performed on sequences of viral genes or portions thereof that are published by others. Thus, it is understood that while the inventive assays utilize information about viral gene sequences or portions thereof, the sequencing of the viral gene or portion thereof may occur before the steps which transform those sequences in the course of the inventive assays.

As described in Example 1, the studies underlying the present invention utilized published sequences for HIV-1 env genes or env gene segments isolated from hundreds of patients by single genome amplification-direct sequencing. Based on the results of the studies reported herein, it is expected that the gene or gene segments can be sequenced by so-called “deep sequencing,” which currently reads shorter segments of a gene but which permits far more reads from a single blood sample. The particular method of sequencing used is not critical to the practice of the invention. While the studies described herein detail the procedure using as the exemplar HIV gene the HIV-1 env gene, the procedures described herein can be used to make similar determinations using other genes. To do so, it is preferable if nucleic acid sequences of the gene selected or of portions thereof (of the same preferred lengths as described above for the env gene) are obtained from samples from at least 20 individuals classified as having had incident infections at the time the samples were obtained, and from at least 20 individuals classified as having had incident infections at the time the samples were obtained, and more preferably from at least about 40, 50, 60 70 or 80 persons in each category, with each larger number of persons being more preferred.

### Aligning Sequences

Once obtained, the sequences are aligned. Conveniently, for sequences from persons infected with HIV-1, the sequences are aligned with reference to the sequence of the HIV-1 reference strain HXB2 (GenBank accession number K03455, discussed above). The GenBank entry sets forth the nucleotide sequence for the complete HIV-1 reference genome and identifies by number within the genomic sequence the starting and ending nucleotides for each gene encoding the viral proteins. The env gene that encodes the envelope (env) polyprotein is identified as extending from position 6225 to position 8795 of the virus's nucleotide sequence. For HIV-2, the sequence of HIV-2 isolate BEN (GenBank accession no. M30502) can be used as the reference sequence to which sequences from a subject's virions are aligned.

Methods of alignment of sequences for comparison are well known in the art. While it is expected that persons of skill in the art are therefore familiar with various alignment algorithms and programs suitable for use in the assays and methods described herein, the following discussion is provided for the reader's convenience. The particular program or method of alignment used is not critical to the practice of the invention so long as it permits counting the number of mismatches between the sequence of a selected gene or segment of a selected HIV gene in multiple HIV virions in a biological sample from a subject.

Various programs and alignment algorithms are described in, for example: Smith and Waterman, Adv. Appl. Math. 2:482 (1981); Pearson and Lipman, Proc. Natl. Acad. Sci. USA 85(8):2444-2448 (1988); Higgins and Sharp, Gene 73(1):237-44 (1988); Higgins and Sharp, Comp Appl Biosci 5(2):151-3 (1989); and Corpet et al., Nucleic Acids Research 16(22):10881-90 (1988). Altschul et al., Nature Genet., 6:119 (1994) presents a detailed consideration of sequence alignment methods and homology calculations.

The NCBI “Basic Local Alignment Search Tool,” or “BLAST” (Altschul et al., J. Mol. Biol. 215:403, 1990) is available from several sources, including the National Center for Biotechnology Information (“NCBI”, Bethesda, Md.) and on the Internet, for use in connection with a number of sequence analysis programs. The BLAST homepage on the NCBI website (which can be found by searching the term NCBI or by searching the term “BLAST”), for example, provides access to a number of specialized searches, including blastn, for aligning any two nucleotide sequences, and the “Needleman-Wunsch Global Sequence Alignment Tool”, which provides an alignment of any two nucleotide sequences of interest using the Needleman-Wunsch alignment criteria. The tool aligns the sequences and shows the matches and mismatches at the corresponding position of each sequence.

More conveniently, the practitioner can use any of a number of programs that permit the alignment of multiple sequences at one time. The website of the European Molecular Biology Laboratory's (“EMBL's”) European Bioinformatics Institute (“EBI”), for example, provides access to five multiple sequence alignment tools, including CLUSTALW, MUSCLE, T-COFFEE, Kalign, and MAFFT. The current iteration of the Clustal series of programs, ClustalW, for example, permits the alignment of hundreds of sequences at one time. The ClustalW program is currently hosted on the internet by EMBL-EBI and can be accessed on any of a number of websites, including those of the EBI and of the Swiss Institute of Bioinformatics.

Further information regarding the CLUSTAL series of programs, including both CLUSTALW and CLUSTALX, and their use can be found in references including: Larkin et al., Bioinformatics, 23:2947-48 (2007); Chenna et al., Nuc Acids Res 31:3497-3500 (2003); Jeanmougin et al., Trends Biochem Sci., 23:403-405 (1998); Thompson et al., Nucleic Acids Res., 25:4876-4882 (1997); Higgins et al., Methods Enzymol., 266:383-402 (1996); and Thompson et al., Nucleic Acids Res., 22:4673-4680 (1994).

Finally, the LANL HIV Sequence Database, described in a previous section, provides a number of database tools. These include as HIValign, a QuickAlign tool which permits the practitioner to enter a sequence from an HIV-1 or HIV-2 virion and determine the particular portion of the HIV-1 or HIV-2 genome from which the sequence originated, and the SynchAlign tool which aligns two sequences to one another or synchronizes a single alignment with a standard HIV reference alignment.

### Determining Mismatches and Hamming Distances

If a nucleic acid sequence of a gene is aligned with the nucleic acid sequence of a second copy of the same gene, each nucleotide of the second copy can be said to occupy a position that corresponds to the same position in the first copy. For convenience of reference, the nucleotides that form a DNA or RNA sequence will sometimes be referred to herein by their nucleobase, or base. Once two sequences of a gene or portion thereof have been aligned, therefore, the base at each position of one sequence can be compared to the base at the corresponding position of the second sequence to find the number of positions at which the two sequences differ. As a simple example, consider a hypothetical case in which two sequences of nine nucleotides are aligned, as follows:

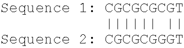

(Following a convention used in the art, including programs such as BLAST, vertical lines are used to denote positions at which two aligned sequences have the same base.) In this example, there is a single base mismatch: the base at position 7 of Sequence 1 (which is “C”, or cytosine) is not the same as the base at position 7 of Sequence 2 (which is “G”, or guanine).

In the inventive methods, the number of mismatched bases in each of the aligned sequences of the HIV gene or gene segment are counted relative to each of the other sequences (for clarity, it is noted that this count does not include any reference sequence, such as that of HBX2, that may have been to align the sequences). Information theory employs a term called “Hamming distance” (abbreviated “HD”) to measure the number of positions at which the symbols in two strings of equal length are different. A “Hamming distance” therefore describes the number of substitutions needed to change one string into the other. Since the present invention concerns comparing two strings of information (gene sequences encoding proteins) which can differ at corresponding positions, this terminology can be used to assist in measuring the mismatches between viral sequences. Thus, in the example above, the Hamming distance between Sequences 1 and 2 is 1. For the sake of clarity, it is reiterated that the word “distance” as used in the phrase “Hamming distance” is a term of art used to refer to the number of mismatches between two given sequences and is not a measure of length.

To illustrate with a simple example, if one is comparing ten nucleic acid sequences, numbered for convenience sequences 1-10, then one first counts any mismatches of bases between sequence 1 and sequence 2, between sequence 1 and sequence 3, between sequence 1 and sequence 4, and so on through sequence 10. One then counts any mismatches between sequence 2 and sequence 3, between sequence 2 and sequence 4, and so on through sequence 10. One then counts the mismatches between sequence 3 and sequence 4, between sequence 3 and sequence 5, and so on to sequence 10, and continues with each sequence in turn until the mismatches between each of the sequences relative to each of the others have been counted. The number of such comparisons may be determined for any number of sequences n by Formula 1:

$$\frac{n \times ( n - 1 )}{2} \qquad Formula 1$$

Thus, in the example above of 10 sequences, the number of HDs obtained will be 45 (10×(10-1)=90, divided by 2=45). While this example was deliberately made simple for the sake of illustration, in actuality, the methods of the invention will generally employ hundreds to thousands of sequences, and therefore thousands to hundreds of thousands of sequence pairs and consequent HDs. Given both the thousands to hundreds of thousands of sequences that may be compared in the course of performing the inventive methods, as well as the further manipulations and processing of the HDs as described in the steps below, the practitioner will appreciate that the steps of the invention necessitate the use of a computer utilizing a program.

### Determining the Distribution of HDs

The number of mismatches between the sequences is then used to determine the distribution of the Hamming distances (mismatches) between each of the sequences relative to the other sequences. To illustrate using the simple example set forth in the preceding section, comparison of the 10 sequences resulted in obtaining 45 HDs (the separate counts of mismatches between the 10 sequences relative to each other). Assume for the sake of this example that 20 of the HDs were 0 (that is, for 20 of the 45 pairs of sequences being compared, there was no mismatch between the pairs), 8 HDs were 1 (8 of the 45 pairs of sequences being compared contained 1 mismatch), 7 HDs were 2 (7 of the 45 pairs of sequences being compared contained 2 mismatches), 5 HDs were 3, 3 HDs were 4, and 2 HDs were 5. In this example, all the HDs were 5 or below and the average of the HDs, 59÷45, is 1.3. In a second hypothetical example, also employing 10 sequences for ease of illustration, the HD distribution of the 45 comparisons might be that 20 of the HDs were 30 (that is, 20 of the 45 pairs of sequences being compared had 30 mismatches between the sequences), 8 HDs were 27, 7 HDs were 25, 5 HDs were 24, 3 HDs were 22 and 2 HDs were 20. In this example, all of the pairs of sequences have HDs above 20, and the average of the HDs is 1217÷45, or 27.

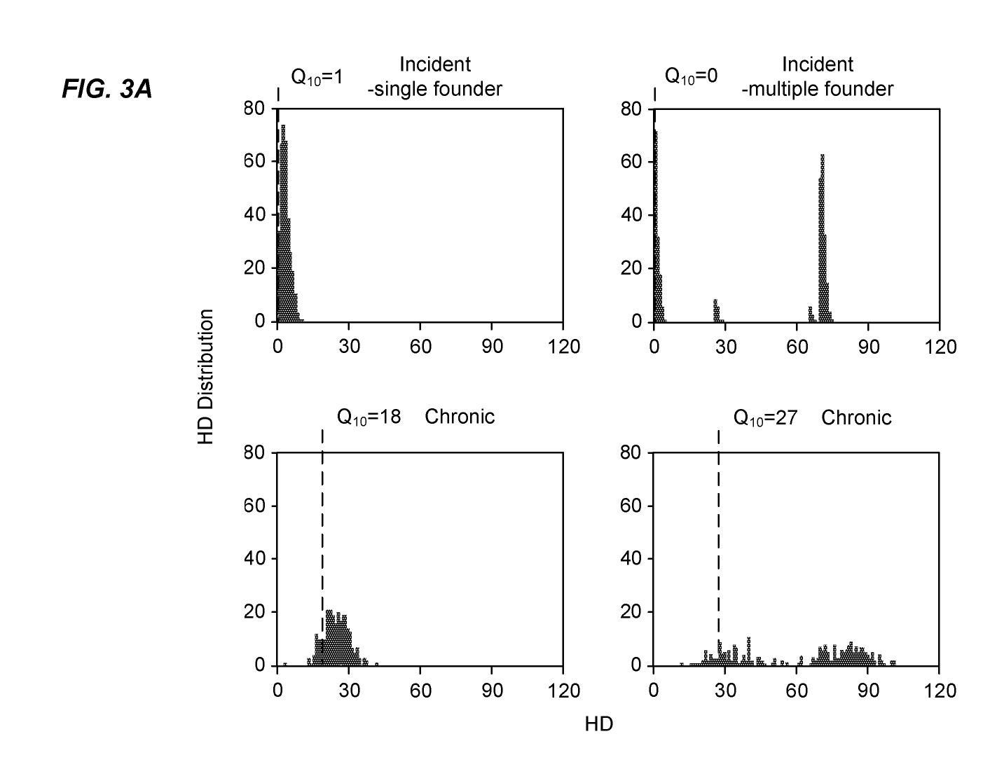

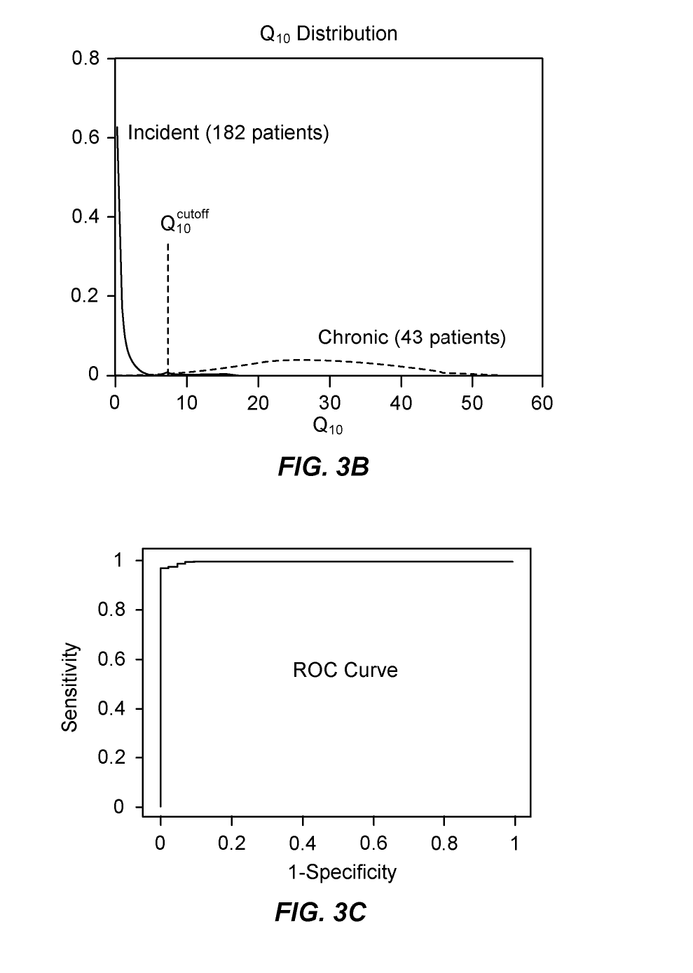

The distribution of the HDs can be determined by, for example, plotting the HDs on a histogram. Conveniently, the HD value is shown on the X (horizontal) axis and the number of occurrences of that value being shown on the Y (vertical axis). For example, referring to FIG. 3A, the upper left graph shows the HD distribution of mismatches in env sequences for an individual with an incident infection (<1 year), while the lower left graph shows the corresponding HD distribution for an individual with a chronic infection. Persons of skill will recognize that, while histograms are a convenient way to visualize a distribution such as the HD distribution, more generally a histogram is a function m, that counts the number of occurrences that fall into each category, or bin, being counted. Thus, while a graph is one way to represent a histogram, more generally, a histogram can be represented by Formula 2:

$$n = {\sum }_{i = 1}^{k} {m}_{i} \qquad Formula 2$$

where n is the total number of observations and k is the total number of bins.

A computer or other device can therefore be programmed to implement the inventive assays by graphing a histogram, by applying Formula 2, or by performing other manipulations of the data that provide the density of distribution of the HD distances of the sequences relative to each other.

### Determining Quantile Values

In the studies underlying the invention, the distribution of mismatches was used to calculate quantiles, Qₓ, where “Q” stands for “quantile,” and “x” is an integer from 1 to 25. The quantile Qₓ denotes the HD value dividing the HD distribution into x % below it and (100-x) % above it. As shown in the Examples, the studies underlying the invention were performed using as an exemplar Q_{X}, Q₁₀, which is a preferred embodiment. The assays could, however, be conducted using other Qₓ values. For example, in other embodiments, the “x” in Qₓ could be 24, 23, 22, 21, 20, 19, 18, 17, 16, 15, 14, 13, 12, 11, 9, 8, 7, 6, 5, 4, 3, 2, or 1, with each successively lower integer being more preferred than the one higher than it (that is, 8 is more preferred than 9, and so on).

As with most binary classifications, there is a trade-off between specificity and sensitivity that is controlled by the choice of the threshold. Any particular degree of specificity or sensitivity desired can be selected by the practitioner using “relative operating characteristic” (or “ROC”) curves. ROC curves are a well established technique for plotting the true positive rate against the false negative rate for a binary classification system as its discrimination threshold is varied. (See, e.g., Pepe, M S, The Statistical Evaluation of Medical Tests for Classification and Prediction, Oxford University Press, Inc. (New York, 2003); Fawcett, T., Pattern Recognition Ltrs, 27:861-874 (2006); Mason and Graham, Quart. J Royal Meterological Soc 128:2145-2166 (2002)); Krzanowski and Hand, ROC Curves for Continuous Data, Chapman & Hall/CRC (Boca Raton, Fla., 2009); and Zhou et al., Statistical Methods in Diagnostic Medicine, John Wiley & Sons, Inc. (New York, 2002). The greater the area under the ROC curve, the more accurate an assay is considered to be.

As described in the Examples, in the inventive assays, the appropriate cutoff value is determined by maximizing the sum of sensitivity and specificity with equal consideration as the putative Qₓ cutoff value is changed incrementally. An “isocost line” can be used for this purpose. (An “isocost line” is a term from economics, and refers to the line on a graph showing all combinations of a given set of inputs which result in the same total cost. For convenience of reference, however, the term “isocost line” is used herein to refer to a line adjacent to a ROC curve that maximizes the sum of sensitivity and specificity with equal consideration.) The sensitivity and specificity are plotted on the ROC curve to find the cutoff value maximizing the two values. Once the cutoff value of Qₓ is determined, the sensitivity is given by the proportion of incident patients having a Qₓ value less than or equal to the cutoff and the specificity is given by the proportion of chronic patients having a Qx value greater than the cutoff. If the Qₓ is greater than the cut-off value, the sample is considered to come from a chronic infection, while if the Qₓ is equal to or lower than the cut-off value, it is scored as an incident infection unless the subject has clinical symptoms of AIDS. If the subject has clinical symptoms of AIDS, however, the subject is scored as having a late stage chronic infection regardless of the subject's Qₓ value. (Treatment of subjects with clinical symptoms of AIDS are discussed in more detail at the end of this section.)

The following hypothetical example shows how sensitivity and specificity is determined by changing the putative Qx cutoff value incrementally. Suppose that the particular HIV gene or portion thereof in question has been sequenced and aligned and the HD distribution determined with respect to a population of persons with known incident or chronic infections. Suppose further that it is found that 90% of the subjects with incident infections have an HD distribution for that gene or portion thereof with a Q₁₀ of 0, 5% have a Q₁₀ of 1, and 5% have a Q₁₀ of 2. A Q₁₀ cutoff value of 1 would then have a 95% sensitivity (defined as the proportion of incident infections identified as incident), while a Q₁₀ cut-off value of 2 would have 100% sensitivity. Suppose too that 97% of the subjects with chronic infections have an HD distribution with a Q₁₀ of 10, 2% have a Q₁₀ of 2, and 1% have a Q₁₀ of 1. Thus, a Q₁₀ cutoff value of 2 has 98% specificity (defined as the proportion of chronic infections identified as chronic). Putting these results together, a Q₁₀ cutoff value of 0 would have 90% sensitivity (since 10% of the incident subjects would have HD distributions with a Q₁₀ value of 1 or 2 and would therefore not be captured by the Q₁₀ value of 0), and a specificity of 100%, since all the chronic subjects would have HD distributions with Q₁₀ above 0. The total of these results would be 90%+100%, or 190%. Setting the Q₁₀ cutoff at 1, in contrast, would give a sensitivity of 95% and a specificity of 99%, for a total of 95%+99%, or 194%. Setting the Q₁₀ cutoff at 2 would give a sensitivity of 100% and a specificity of 97%, for a total of 100%+97%, or 197%. Thus, in this example, a Q₁₀ cutoff of 2 maximizes the sum of the sensitivity and specificity when this gene or portion thereof is used in the inventive assays. If a blood sample is now obtained from a new subject whose HIV infection has not previously been classified as being incident or chronic, it can now be evaluated by determining the HD distribution and comparing the Q₁₀ of the subject's HD distribution to the cutoff value. If it is above 2, the subject would be classified as having a chronic infection, and if it is 2 or below, the subject would be classified as having an incident infection unless the subject was presenting with one or more clinical symptoms of AIDS, as discussed further below.

In the studies underlying the present invention, the HIV-1 env gene was used as an exemplar gene. These studies revealed that, when the full length of the HIV-1 env gene was used, a Q₁₀ cutoff of 7 maximized the sensitivity and specificity of the assay; thus subjects with a HD distribution with a Q₁₀ value greater than 7 or more could be classified as being chronic. (With some exceptions, discussed in more detail below, persons with a Q₁₀ equal to or less than 7 have an incident infection.)

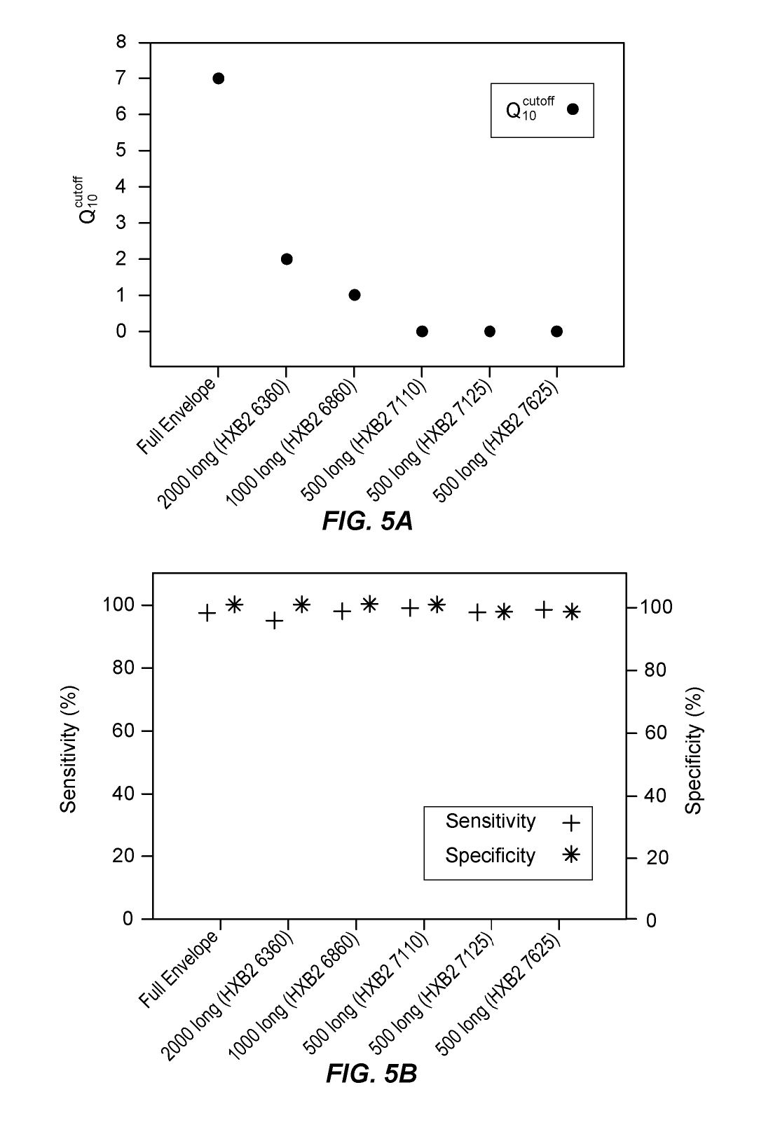

Further studies using the exemplar gene env revealed that the Q₁₀ cutoff value providing the maximum balance of sensitivity and specificity decreases as the length of the gene sequence used shortens. As shown in FIG. 5A, as the length of the portion of the env gene used in the methods was shortened, the Q₁₀ cutoff value dropped from 7, for the whole gene, to 2, for a 2000 base segment, to 1, for a 1000 base segment, and to 0, for each of three 500 base segments, each of which started from a different position within the gene. These findings indicate that use of shorter portions of a HIV gene in the inventive methods will result in smaller Q₁₀ cutoff values. Use of longer sequences is preferred over shorter sequences in the inventive methods. Thus, use of the full length gene sequence is preferred over use of a 2000 base sequence, which in turn is preferred over the use of 1000 base sequences, which in turn is preferred over use of 500 base sequences. It is contemplated that as sequencing methods continue to become faster and less expensive, sequencing of the full length sequence of HIV genes from large numbers of virions from a subject will become increasingly cost-effective and therefore will become increasingly common in practicing the inventive methods.

The assays successfully distinguish incident from chronic infections, where the chronically infected persons have not advanced into AIDS. In later stages of HIV infection, as end point disease is approached, viral diversity has been reported to decline. Thus, persons with late stage infections could be incorrectly classified as having an incident infection if the sequencing based assay alone is used. It is anticipated that samples from persons with late stage disease will typically not be evaluated by the methods of the invention; their clinical symptoms are usually apparent and are unlikely to leave a doubt in the practitioner's mind as to whether the subject has an incident or a chronic infection. If, however, there is a question, it can be resolved by use of a standard diagnostic method such as counting the subject's CD4+ T cells, to confirm that the clinical symptoms are due to the presence of late stage HIV disease, or AIDS. A low CD4+ T cell count would then be indicative that the subject has a late stage chronic infection, regardless of the Q₁₀ value of the subject's HD distribution.

If, however, one or more samples show a low viral diversity when evaluated by the gene sequencing methods of the invention, the practitioner can if desired further determine whether the sample comes from a person with a recent infection or from a person with late stage disease by correlating the low viral diversity with the presence or absence of clinical symptoms in the subject indicative of late stage HIV disease. In some preferred embodiments, the clinical symptom indicative of late stage HIV disease is a low CD4+ T cell count. The Centers for Disease Control and Prevention defines AIDS as an HIV-1 infected person with either a CD4+ T cell count of less than 200 cells per microliter or the occurrence of an opportunistic infection or malignancy. In some embodiments, the clinical symptom of late stage HIV disease is a CD4+ T cell count below 200 per microliter or the occurrence of an opportunistic infection or malignancy.

Determining Cutoff Values for HIV Genes Other than Env

As noted earlier, HIV genes other than env can be used in the inventive methods. The practitioner selects a gene to use as a marker of whether a subject has an incident or a chronic HIV infection. For example, the practitioner might select the HIV-1 gag gene or the HIV-2 pol gene. The practitioner then finds a group of published sequences for a population of persons who were determined to have incident or chronic HIV infections at the time the samples were taken or, if a number of sequences for the selected gene from persons determined to have incident or chronic infections are not published, obtains samples (such as blood samples) taken from such persons, sequences multiple copies of the gene of interest or a portion of the gene at least about 500 bases in length from in each subject, aligns the sequences, and compares the bases present at the corresponding position of one sequence relative to the base present at the same position in each of the other sequences (thereby creating a series of sequence pairs to be compared, such as the first sequence and the second sequence, the first sequence and the third sequence, and so on) and counts the number of mismatches at each position to generate Hamming distances (“HDs”) for each sequence pair. The computer then determines the distribution of the HDs (that is, the number of mismatches) among all possible sequence pairs for that subject to create a HD distribution for that subject. This process is repeated for a plurality of subjects with incident infections and for a plurality of persons with chronic infections and the HD distributions for the two populations of subjects are compared to determine the difference in distribution identifying incident from chronic infections. Given the results in the exemplar studies reported herein, it is expected that the Qₓ values of subjects with incident infections will be significantly lower than those of subjects with chronic infections. Once the cutoff value between incident and chronic infections for any particular Qₓ for the selected gene has been determined, as set forth above, the Qₓ value of the HD distribution of the selected gene or portion thereof can be used to classify the infection of any new subject as incident or chronic, as described above.

### Use for Determining Transmission Rates in Populations

As noted in the Introduction, the inventive methods can be used to determine whether an intervention, such as a vaccine or a drug that is a candidate for prophylactic use, is reducing the rate of transmission of HIV-1 or HIV-2 in a population, such as the population of a city, state, or province, in which the intervention is being tested. To do so, the entity monitoring the effect of the intervention obtains samples from subjects in the population who have had the benefit of the intervention for a period of time, such as a half year or a year, obtains sequence data for a selected HIV gene or portion thereof to the manipulation described above for a plurality of subjects, determines the rate of incident (recent) infections in persons having the benefit of the intervention and compares that rate of incident infection to the rate of incident infection of either a control group (for example, a like group in the same geographic area receiving a placebo) or of persons in the geographical area prior to the introduction of the intervention to determine whether the intervention has reduced the rate of transmission in the population.

Computer Implementation

As noted above, the large number of sequences and resulting data to be manipulated in the course of the inventive methods requires the use of a computer processor. Alignments of the gene or gene segment sequences may be done by the practitioner, or the sequences may have already been aligned (for example in a publication), and the data regarding the alignments may then be obtained by the practitioner to be subjected to further manipulation in embodiments of the inventive methods. Data on already aligned sequences can be input for use by a program directing the computer to perform the inventive methods on such sequences. Alternatively, the sequence alignments may be performed on the internet using publicly available programs into which one pastes or enters in the sequences to be aligned, such as those described in a preceding section or the practitioner can enter sequences of HIV genomes, genes, or portions thereof into a computer program that aligns the sequences. However the practitioner obtains aligned sequences, the sequences are then processed by a program that directs the performance of the other steps of the inventive methods as described below.

Once a plurality of sequences of a HIV gene or of a HIV gene segment have been obtained and aligned, a computer program compares the bases present at the corresponding position of one sequence relative to the base present at the same position in each of the other sequences (thereby creating a series of sequence pairs to be compared, such as the first sequence and the second sequence, the first sequence and the third sequence, and so on) and counts the number of mismatches at each position to generate Hamming distances for each sequence pair. The computer program then determines the distribution of the Hamming distances (number of mismatches) among all possible sequence pairs. The computer then calculates a quantile Qₓ, which typically will have been selected and entered by the practitioner, wherein x is an integer selected as described above, to obtain a result R, and compares the result to a cut-off value C. If result R is lower than cut-off value C, the computer classifies the subject's infection as being incident (unless there is clinical data of AIDS, as discussed below), whereas if result R is cut-off value C or higher, the subject's infection is classified as being chronic. In some embodiments, the computer can further correlate the result R with a subject's clinical symptom of AIDS, such as a CD4+ cell count of 200 CD4+ T cells per microliter of the subject's blood or lower. In these embodiments, the computer is provided with instructions to score that subject as having chronic, late-stage HIV disease regardless of the value of the result R.

In other embodiments, a computer is used in methods to determine cutoff values distinguishing incident from chronic infections using any HIV gene. (While these methods are applicable to genes from either HIV-1 and HIV-2, to determine cutoff values, for each method, the infections being compared should be of the same type of HIV; that is, if the methods are used to determine a cutoff value using the HIV-1 gag gene, the incident and chronic infections being used to develop the cutoff value should be of HIV-1.)

In these methods, the practitioner selects a gene which he or she desires to use as a marker of whether a subject has an incident or a chronic HIV infection. For example, the practitioner might select the HIV-1 gag gene or the HIV-2 pol gene. The practitioner can then find a group of published sequences for a population of persons who were determined to have incident or chronic HIV infections at the time the samples were taken or, if a number of sequences for the selected gene from persons determined to have incident or chronic infections are not available, can take samples (such as blood samples) from such persons, sequence multiple copies of the gene of interest or a portion of the gene at least about 500 bases in length from in each subject, align the sequences, and have a computer program compare the bases present at the corresponding position of one sequence relative to the base present at the same position in each of the other sequences (thereby creating a series of sequence pairs to be compared, such as the first sequence and the second sequence, the first sequence and the third sequence, and so on) and counts the number of mismatches at each position to generate Hamming distances for each sequence pair. The computer then determines the distribution of the Hamming distances (number of mismatches) among all possible sequence pairs for that subject to create a HD distribution for that subject. This process is repeated for a plurality of subjects with incident infections and for a plurality of persons with chronic infections and the HD distributions for the two populations of subjects are compared to determine the difference in distribution identifying incident from chronic infections. It is expected that subjects with incident infections will be grouped with a much lower Q₁₀ that will subjects with chronic infections. What the distribution study does is determine the cutoff value for the selected gene, or shorter lengths thereof (of at least about 500 bases) for any given Qx, just as Q₁₀ cutoff value for the env full length gene and for shorter lengths of it were determined as set forth in the Examples.

Once the cutoff value between incident and chronic infections for any particular Qₓ for the selected gene has been determined, as set forth above, the infection of any new subject can be classified as incident or chronic by determining the HD distribution of the selected gene in the virions in a sample from the patient, as described above.

Computer systems used to implement the methods described herein typically comprise a processor, an input device coupled to the processor, an output device coupled to the processor, and one or more memory devices coupled to the processor. The input device may be, for example, a keyboard or a mouse. The output device may be, for example, a printer, a plotter, a computer screen, a magnetic tape, a removable hard disk, a thumb drive or a floppy disk. The memory device may be, for example, a hard disk, a floppy disk, a magnetic tape, an optical storage such as a compact disc (CD), a digital video disc (DVD), a dynamic random access memory (DRAM), a read-only memory (ROM). The memory device includes a computer code. The computer code includes an algorithm for implementing the steps of the inventive methods, including at least the steps of: (i) comparing the bases at each position of the nucleic acid sequences to calculate Hamming distances (HDs) for each sequence pair, (ii) creating a distribution of HDs from the calculated HDs, (iii) determining a quantile, Qₓ, provided by the operator, which quantile denotes the HD value dividing the HD distribution in x % below it and (100-x) % above it, and (iv) determining whether the Q, of the subject's gene or portion thereof is equal to or lower than cutoff value, C, or higher than the cutoff value, C.

The processor executes the computer code necessary to perform the steps described above. The memory device includes input data required by the computer code. The output device displays output from the computer code. Thus the present invention discloses a process for deploying or integrating computing infrastructure, comprising integrating computer-readable code into the computer system, wherein the code in combination with the computer system is capable of performing a method for implementing the inventive assays.

### EXAMPLES

### Example 1

This Example sets forth the methods used in the studies underlying the invention.

A. Sequence Data Sources.

The HIV-1 env sequences of 182 incident and 43 chronic patients were collected from the published data set in Keele et al., Proc Natl Acad Sci USA, 105:7552-7 (2008) (hereinafter, “Keele”), Abrahams et al., J Virol, 83:3556-67 (2009) (“Abrahams”), and Bar et al., J. Virol., 84:6241-7 (2010) (“Bar”). The cohorts studied were located in the United States, Trinidad, South Africa, Malawi, and Canada. All of the 5596 strains analyzed in the studies reported herein were obtained by single genome amplification and sequencing. The incident subjects were sub-staged according to the Fiebig classification (Fiebig, supra): 1 subject was in stage I, 74 subjects were in stage II, 24 subjects were in stage III, 23 subjects were in stage IV, 44 subjects were in stage V, and 16 subjects were in stage VI. The routes of exposure included 92 transmissions by heterosexual sex, 16 transmissions in men who had had sex with men (MSM), and 12 transmissions in intravenous drug users (IDU). For other subjects, the route of transmission was unknown.

B. ROC Analysis

Following methods described by Metz (Metz, Semin Nucl Med, 8:283-298 (1978)), the proportion of incident infections being correctly identified as incident, sensitivity, is plotted against the proportion of misclassification of chronic infections as incident, 1-specificity, as the putative Q₁₀ cutoff value is incrementally changed. The optimal cut-off value is determined by the isocost line, maximizing the sum of sensitivity and specificity with equal consideration.

### Example 2

This Example reports the results obtained using the methods described in Example 1.

A meta-analysis was performed by collecting 5596 sequences generated by single genome amplification-direct sequencing (Palmer et al., J Clin Microbiol 43: 406-413 (2005); Salazar-Gonzalez et al., J Virol 82: 3952-3970 (2008)) from 182 incident and 43 chronic cases (Keele, Abrahams and Bar, all supra). The incident subjects were classified as recent HIV infections either by symptoms of acute infection or serologic evidence and the chronic subjects were reported to have an infection period of longer than 1 year, as set forth in Example 1. Incident infections were categorized into either single-variant or multi-variant transmission (Keele, Abrahams and Bar, all supra). The diversification can be quantified using the number of base differences between a pair of sequences, i.e., their Hamming distance (HD): HIV-1 env diversity is the average number of base differences among all possible pairs of sequences sampled from a patient, divided by the sequence length. The env variance is the variance of the number of base differences among the sequences divided by the sequence length.

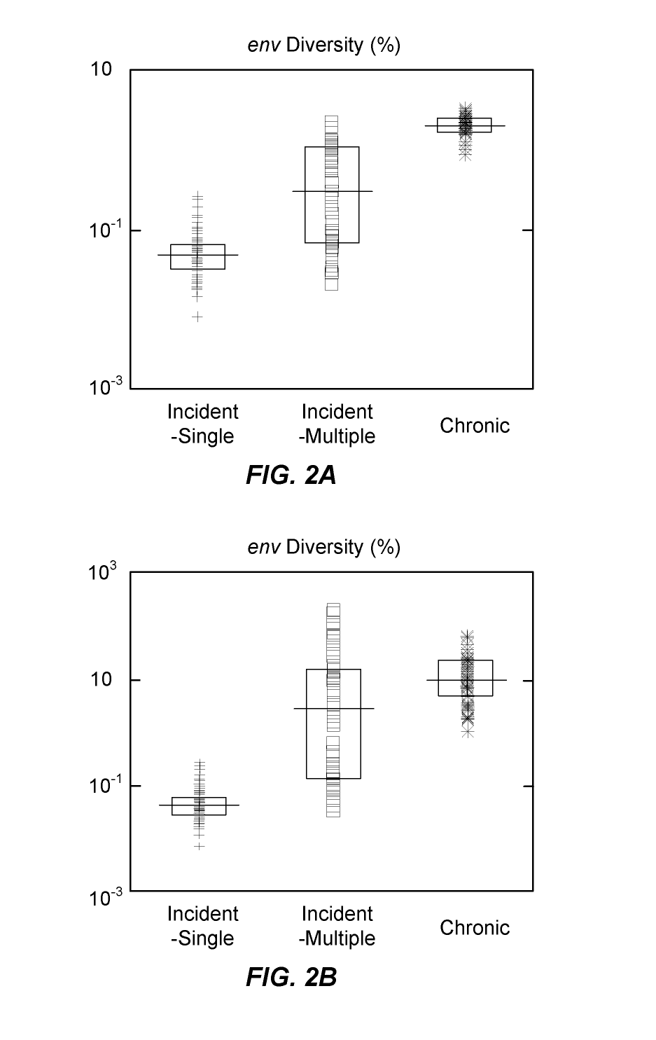

The high level of viral sequence diversity associated with multi-variant transmissions suggests that a simple measure of the diversity or variance might misclassify early stages of individuals whose infection started with multiple founder viruses as being chronically infected. Indeed, as shown in FIGS. 2A and B, the level of env diversity of around one third of the incident multi-variant cases overlaps with those of chronic subjects. Furthermore, the third quartile of the env variance of the incident subjects with multiple founder strains is greater than the median env variance of the chronic subjects. Neither envelope gene diversity nor variance provides clear discrimination between incident infections originating from multiple founder strains and chronic infections.

### Example 3

This Example continues the discussion of the results obtained in the studies underlying the invention.

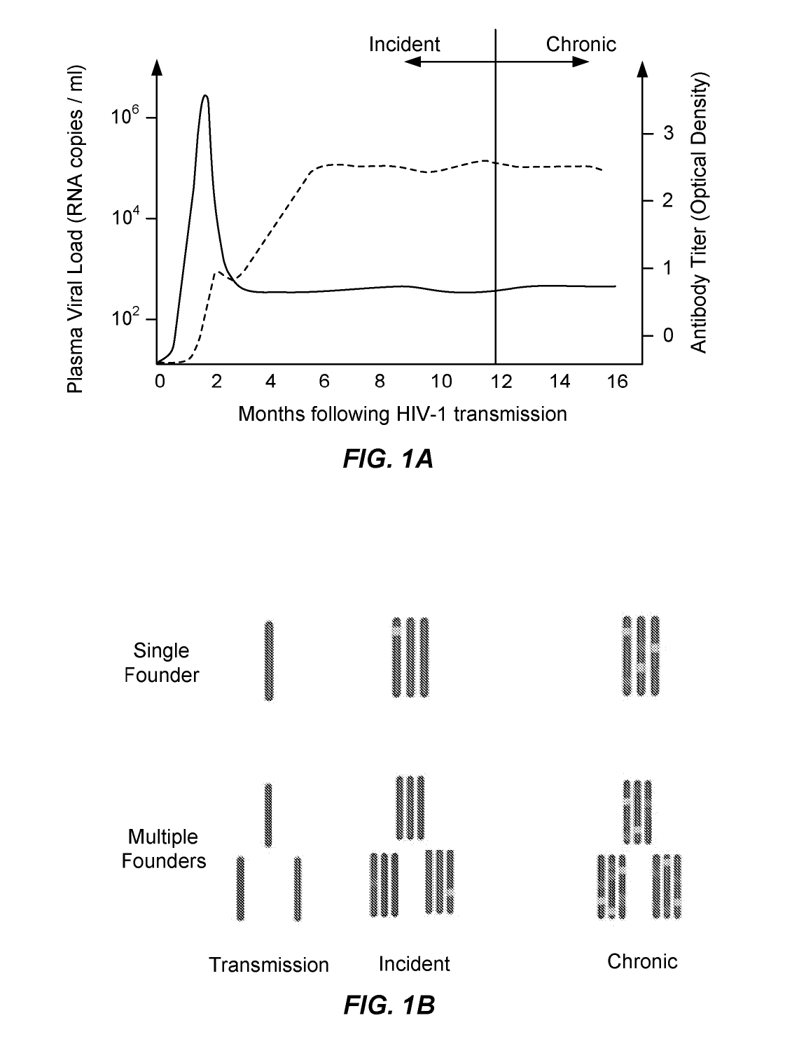

An alternative signature was sought in the HD distribution that discriminates chronic and incident infections. At an early phase, there should exist a fair number of identical or nearly identical sequences in each lineage of transmitted strain. Indeed, FIG. 3A shows that the first peak of the HD distribution of incident cases including both single founder (FIG. 3A top left) and multiple founder infections (FIG. 3A top right), is located in the region of very low Hamming distances, implying the presence of closely related sequences. As infection progresses and the HIV population diversifies, the proportion of similar sequences should decline (FIG. 1B); in fact, the proportion of identical sequences has been found to decrease exponentially as a function of time post infection (Keele, supra, Lee et al., J Theor Biol., 261(2):341-60 (2009)). FIG. 3A confirms that chronic subjects have a negligible frequency of sequence pairs in the region of low HD values, suggesting the absence of closely related sequences. This signature was clarified by quantifying the tail characteristics of the HD distribution: the 10% quantile for HD, Q₁₀, i.e., the HD value dividing the HD distribution into 10% below it and 90% above it was measured. FIG. 3B highlights the difference between the distribution of the Q₁₀ statistics for the 182 incident infection samples and that for the 43 chronic samples. Here, the 182 incident patients included 102 single founder and 80 multiple founder cases. The incident Q₁₀ distribution (gray line in FIG. 3B), which includes both single and multiple founder infections, is visibly disparate from the chronic distribution (black line in FIG. 3B).

The recognition that the Q₁₀ distribution was clearly different between incident and chronic infection led to devising a binary classification test to identify samples from incident infections as being significantly different from the population of chronic infections. If Q₁₀ was greater than the cut-off value Q₁₀^{cut-off}, the sample was judged to be a chronic infection and otherwise the sample was scored as an incident infection. As with most binary classifications, there is a trade-off between specificity and sensitivity that is controlled by the choice of the threshold. The cut-off value of Q₁₀^{cut-off} is objectively determined from an analysis of the receiver operating characteristic (ROC) curve (Pepe, M S. The Statistical Evaluation of Medical Tests for Classification and Prediction. New York: Oxford University Press, 2003). The isocost line for Q₁₀^{cut-off} indicates 7 is the optimal value. Whereas simple measures of viral diversity and variance fail to discriminate chronic samples from incident ones, the binary classification test statistically differentiates the two groups. All of the 43 chronic subjects showed Q₁₀ values greater than the threshold of 7, indicating a specificity of 100%. Only 5 out of 182 incident subjects had Q₁₀ values greater than the threshold; the measured sensitivity is 97.3% and the majority of the 5 misclassified subjects were infected through intravenous drug use. These high levels of sensitivity and specificity convincingly suggest the possibility of using the tail characteristics of the HD distribution as a biomarker for identification of incident infections. Measuring HD distribution is advantageous because it can be easily measured in a cross-sectional sample of infected individuals, requiring only a single blood draw.

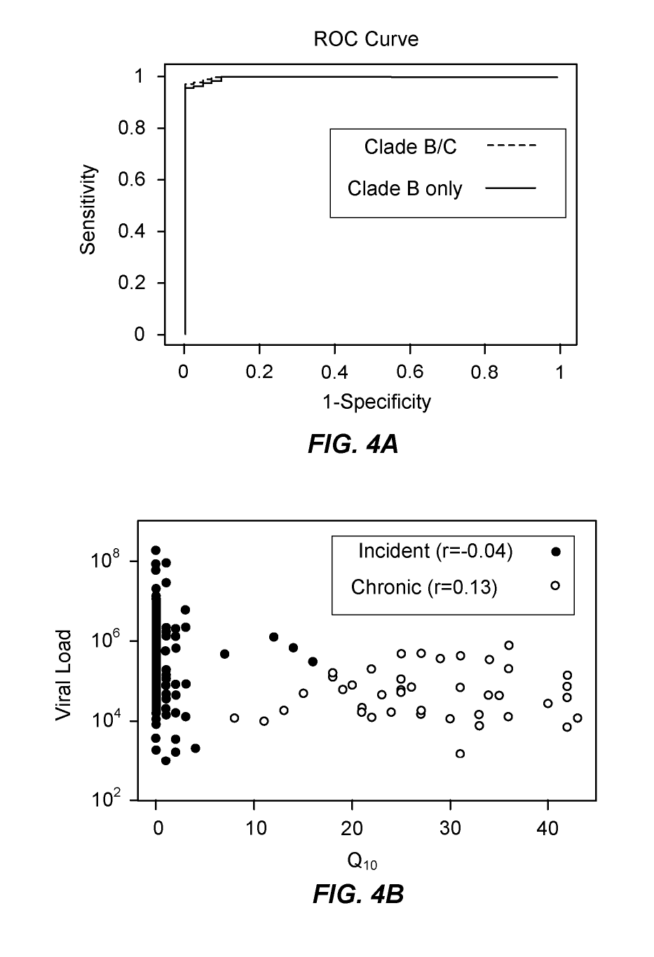

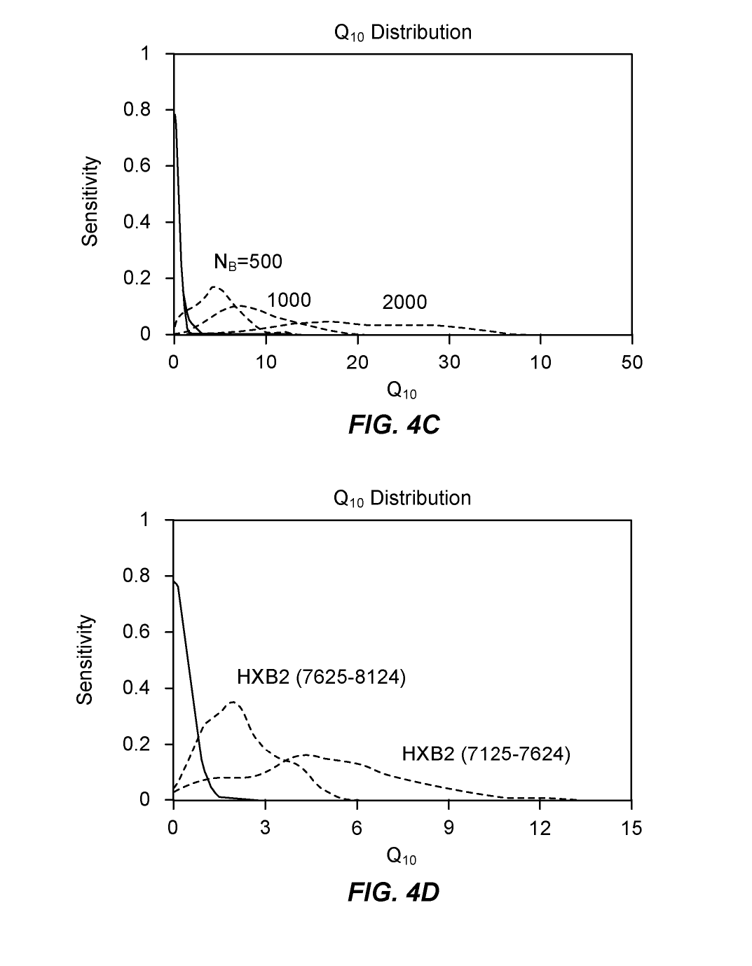

Further analyses performed in the studies underlying the invention show that this biomarker was robust in the face of changes of viral-specific and host-specific factors such as the viral subtype, the viral load of subjects, and the length and location of the sampled envelope gene sequences. FIG. 4A shows the ROC curve of the Q₁₀ distributions when the dataset of subtype C infections are excluded. The area under the ROC curve with subtype B infections remained the same as that with both subtype B and C infections, 0.998, implying that the biomarker is not sensitive to the clade of the viral strains. The ROC curve with only subtype B infections provides a sensitivity of 95.6% and a specificity of 100% with Q₁₀^{cut-off}=7. This is presumably because the dynamics of early HIV-1 diversification is not greatly affected by viral subtype. In contrast, the existing serologic assays have significantly different window periods of incident infections among subtype B and other subtypes (Busch et al., AIDS 24: 2763-2771 (2010)). Little association is observed between the biomarker and the viral load. FIG. 4B shows the scatter plot of Q₁₀ values and viral loads measured from both incident and chronic subjects. The correlation coefficients were −0.04 for incident subjects and 0.13 for chronic subjects, suggesting that the biomarker is not sensitive to a particular patient's viral load.

The sensitivity and specificity of the assay remained very high under changes of either the length or region of the envelope gene. While the changes in the incident Q₁₀ distribution by varying the length of the env gene sequenced are minor, the mean of the chronic Q₁₀ distribution decreases substantially as the length of the env gene sequenced decreases (FIG. 4C). Despite this dependence, the sensitivity and specificity remained markedly high, 95.1% or greater, regardless of whether 500, 1000, 2000 base long env segments or the full env gene was used as Q₁₀^{cut-off} values were controlled objectively based on the ROC curve analysis (see FIG. 5A). These analyses indicate that read lengths of HIV env as short as 500 bases do not affect the accuracy of the assay.

Chronic Q₁₀ distributions show a considerable amount of variation with the choice of the location within env. As FIG. 4D displays, the 500 base long segment of env encompassing the major portion of the V3 loop, HXB2 7125-7624, shows the greatest mean of Q₁₀ and the segment of HXB2 7625-8124 shows the smallest mean. These differing observed distributions imply that, in chronic infections, purifying selections keep certain sections of env quite conserved despite a long period of infection. The presence of purifying selections in chronic infection has been reported (Edwards et al., Genetics, 174:1441-53 (2006)). However, the impact of purifying selection does not appear to be strong enough to weaken the signature of chronic infection. The power of discrimination even in the least sensitive region (HXB2 7625-8124) is comparable to the power of the entire env; the sensitivity is 98.4% and the specificity is 97.7% with the optimal Q₁₀^{cut-off}=0; the 10% quantile of the HD distributions of 179 out of the 182 incident subjects was 0 but only a single chronic subject had a 10% quantile value of 0. As summarized in FIG. 5, it thus appears that the HIV incidence assay described herein is robust to changes of the length and location of HIV env.

### Example 4

This Example discusses the results described in the previous Examples.

Simple measures of the viral diversity or variance failed to distinguish chronically infected individuals from those infected with multiple founder viruses but who are at an early stage. This is due to the fact that distinct founder strains in multi-variant transmissions caused increased HD diversity and variance (see FIG. 2 and FIG. 3A). In contrast to these simple markers, the studies reported herein show that sequence similarity can be used as a biomarker having high specificity and sensitivity and that is robust in the face of viral and host specific factors such as the clade of the viral strain, the viral load, and the length and location of sequences in the HIV-1 envelope gene. Indeed, even persons infected with multiple founder viruses, there still exists a tangible number of very closely related sequences within each lineage of the founder virus at the incident stage, which yields lower Q values than are present in individuals in chronic stage. Consequently, the preferred quantile, 10%, of the HD distribution, instead of the mean or variance of the HD distribution, was found to be a robust measure for distinguishing incident infections, including multi-variant transmissions, from chronic infections.

One foreseeable issue for the development of a genome-based HIV incidence assay is the decline in viral sequence diversity that occurs during the later stages of infection (Shankarappa et al., J Virol, 73:10489-502 (1999); Lee et al., PLoS Comput Biol., 4:e1000240 (2008)). This common phenomenon of diversity decline as the end point disease is approached implies that one cannot exclude the possibility that a sequencing based assay might identify some subjects with late infection as having an incident infection. Such late stage patients can be identifiable, however, based on clinical criteria by introducing additional measures such as the patient's CD4+ T cell count. A low CD4+ cell count in a subject, such as fewer than 200 CD4+ cells per microliter of blood, would indicate that that subject had a chronic infection rather than an incident infection.

The datasets used in the present studies were obtained by single genome amplification and sequencing which conventionally samples less than 100 sequences. On the other hand, “deep sequencing” (Metzker M L, Nat Rev Genet., 11:31-46 (2009)) is capable of producing more than 10,000 reads from a single blood sample. The estimation of tail characteristics of a distribution such as Q₁₀ requires a substantially greater sample size than the estimation of central characteristics such as the mean or median. One of the limitations of the current deep sequencing platforms is that a relatively short read length (400-600 base long) is produced in comparison to single genome amplification (SGA) and Sanger sequencing. The analysis herein, however, indicates that short read lengths do not affect the accuracy of the assay, and that data from even current deep sequencing methods could also be used in assays of the invention. Further, as deep sequencing techniques are improved and sequencing costs continue to come down, it is likely deep sequencing will not be limited to short read lengths. As sequencing errors are reduced and deep sequencing re-sampling issues are resolved, deep sequencing, with its large number of reads, is likely to become a preferred method for obtaining sequences for use in assays of the invention.

The results reported herein demonstrate that a sequencing based HIV incidence assay is a powerful tool for identifying incident infections in a highly accurate manner. The rapid and continuing decrease in the cost of DNA sequencing over the past decades suggests that the inventive assay will become increasingly cost-effective and will be widely adopted in clinical practice.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. A computer-implemented method of determining with a high degree of sensitivity and specificity whether a subject infected with human immunodeficiency virus-1 (“HIV-1”) having a gene (an “env gene”) encoding an envelope polypeptide has a chronic infection, said method comprising:
(a) obtaining a nucleic acid sequence of said env gene from each of a plurality of HIV-1 virions from said subject, each sequence being (i) of at least about 500 contiguous bases, (ii) having at least about 500 contiguous bases from the same genomic location in the gene as the other sequences, and (iii) aligned so that said at least about 500 contiguous bases of (a)(ii) are in the same position within their respective sequences,
(b) counting, for each sequence relative to each of the other sequences, the number of instances in which the nucleic acid bases at the same position do not match, thereby generating a Hamming distance (“HD”) for each sequence relative to each of the other sequences,
(c) determining a HD distribution from the HD of each sequence relative to each of the other sequences, and,
(d) calculating from said HD distribution a 10% quantile, “Q₁₀”, by determining the HD value which divides the HD distribution into 10% below that HD value and 90% above that HD value, wherein,
when said nucleic acid sequence in step (a) (iii) is about 500 bases in length and said Q₁₀ value is higher than 0, the infection is a chronic infection,
when said nucleic acid sequence in step (a) (iii) is about 1000 bases in length and said Q₁₀ value is higher than 1, the infection is a chronic infection,
when said nucleic acid sequence in step (a) (iii) is about 2000 bases in length and said Q₁₀ value is higher than 2, the infection is a chronic infection, and
when said nucleic acid sequence in step (a) (iii) is about the full length of the env gene and said Q₁₀ value is higher than 7, the infection is a chronic infection,
thereby determining with a high degree of sensitivity and specificity whether said subject has an incident infection.

2. The method of claim 1, wherein the sequences of nucleic acid bases of said env gene in step 1(a)(i) are from 20 or more HIV-1 virions from said subject.

3. The method of claim 1, wherein the sequences of nucleic acid bases of said env gene in step 1(a)(i) are from 1000 or more HIV-1 virions from said subject.

4. The method of claim 1, wherein said aligned contiguous bases of step (a) (iii) are of about 1000 bases of the env gene.

5. The method of claim 1, wherein said aligned contiguous bases of step (a) (iii) are of about 2000 bases of the env gene.

6. The method of claim 1, wherein said aligned contiguous bases of step (a) (iii) are of about the entire length of the env gene.

7. A computer-implemented method of determining with a high degree of sensitivity and specificity whether a subject infected with human immunodeficiency virus-1 (“HIV-1”) having a gene (an “env gene”) encoding an envelope polypeptide has an incident infection, said method comprising:
(a) obtaining a nucleic acid sequence of said env gene from each of a plurality of HIV-1 virions from said subject, each sequence being (i) of at least about 500 contiguous bases and (ii) having at least about 500 contiguous bases from the same genomic location in the gene as the other sequences, and (iii) aligned so that said at least about 500 contiguous bases of (a)(ii) are in the same position within their respective sequences,
(b) counting, for each sequence relative to each of the other sequences, the number of instances in which the nucleic acid bases at the same position do not match, thereby generating a Hamming distance (“HD”) for each sequence relative to each of the other sequences,
(c) determining a HD distribution from the HD of each sequence relative to each of the other sequences, and,
(d) calculating from said HD distribution a 10% quantile, “Q₁₀”, by determining the HD value which divides the HD distribution into 10% below that HD value and 90% above that HD value, wherein,
when said nucleic acid sequence in step (a) (iii) is about 500 bases in length and said Q₁₀ value is 0, and the subject does not have a clinical symptom of AIDS, the infection is an incident infection,
when said nucleic acid sequence in step (a) (iii) is about 1000 bases in length and said Q₁₀ value is 1 or lower and the subject does not have a clinical symptom of AIDS, the infection is an incident infection,
when said nucleic acid sequence in step (a) (iii) is about 2000 bases in length and said Q₁₀ value is 2 or lower and the subject does not have a clinical symptom of AIDS, the infection is an incident infection, and
when said nucleic acid sequence in step (a) (iii) is about the full length of the env gene and said Q₁₀ value is lower than 7 and the subject does not have a clinical symptom of AIDS, the infection is an incident infection,
thereby determining with a high degree of sensitivity and specificity whether said subject has an incident infection.

8. The method of claim 7, wherein said clinical symptom of AIDS is a CD4+ T cell count of 200 CD4+ T cells or less per microliter.

9. The method of claim 7, wherein the sequences of nucleic acid bases of said env gene in step 1(a)(i) are from 20 or more HIV-1 virions from said subject.

10. The method of claim 7, wherein the sequences of nucleic acid bases of said env gene in step 1(a)(i) are from 1000 or more HIV-1 virions from said subject.

11. The method of claim 7, wherein said aligned contiguous bases of step (a) (iii) are of about 1000 bases of the env gene.

12. The method of claim 7, wherein said aligned contiguous bases of step (a) (iii) are of about 2000 bases of the env gene.

13. The method of claim 7, wherein said aligned contiguous bases of step (a) (iii) are of about the entire length of the env gene.

14. A computer-implemented method of determining with a high degree of sensitivity and specificity whether an individual infected with human immunodeficiency virus (“HIV”) has an incident infection or a chronic infection, said method comprising:
(a) obtaining sequences of at least 500 contiguous nucleic acid bases of a selected portion of a selected HIV gene or of the entire selected HIV gene from a plurality of HIV virions from said individual,
(b) aligning said sequences of contiguous nucleic acid bases of said selected portion of said selected HIV gene or of said entire HIV gene so that said bases have positions within their respective sequences comparable to the positions of the bases in the other sequences,
(c) comparing the nucleic acid base in each position in one sequence to the nucleic acid base at the same position in each of the other sequences and counting the number of instances in which the nucleic acid bases at the same position in each sequence pair do not match, thereby generating Hamming distances (“HDs”) for each sequence relative to each of the other sequences,
(d) creating a HD distribution from the HDs generated in step (c),
(e) calculating from said HD distribution a selected quantile, “Qₓ”, wherein “Qx” is an integer from 1 to 20, to obtain a HD value which divides the HD distribution into x % below it and (100-x) % above it,
(f) selecting a value at which sensitivity and specificity are maximized, thereby selecting a cut-off value C,
(g) comparing said HD value of step (e) to said cutoff value C of step (f) to obtain a result, R,
wherein a result R above the cut-off value C indicates the infection is a chronic infection.

15. The method of claim 14, further wherein a result R at or below the cut-off value C and the absence of a clinical symptom of AIDS indicates that the infection is an incident infection.

16. The method of claim 14, wherein said clinical symptom of AIDS is a CD4+ T cell count of 200 CD4+ T cells or less per microliter.

17. The method of claim 14, wherein x is an integer between 1 and 25.

18. The method of claim 14, wherein x is an integer between 1 and 15.

19. The method of claim 14, wherein x is 10.

20. The method of claim 14, wherein the sequences of nucleic acid bases of a selected HIV gene from the plurality of HIV viruses from said subject are from 50 or more HIV virions from said subject.

21. The method of claim 14, wherein the sequences of nucleic acid bases of a selected HIV gene from the plurality of HIV virions from said subject are from 1,000 or more HIV virions from said subject.

22. The method of claim 14, wherein said HIV is HIV-1.

23. The method of claim 22, wherein said HIV-1 gene is selected from the group consisting of env, pol, nef, and gag.

24. The method of claim 23, wherein said HIV-1 gene is env.

25. The method of claim 14, wherein said nucleic acid sequences are about 500 nucleotide bases in length.

26. The method of claim 14, wherein said nucleic acid sequences about 1000 nucleotide bases in length.

27. The method of claim 14, wherein said nucleic acid sequences are about the length of the selected HIV gene.

28. A computer-implemented method of determining whether an individual infected with a human immunodeficiency virus (“HIV”) has an incident infection, a chronic infection, or a late stage chronic infection, said method comprising:
(a) obtaining sequences of at least about 500 contiguous nucleic acid bases of a selected portion of a selected HIV gene or of the entire selected HIV gene from a plurality of HIV virions in said individual,
(b) aligning said sequences of contiguous nucleic acid bases of said selected portion of said selected HIV gene or of said entire HIV gene to permit comparing nucleic acid bases present at the same positions in each sequence,
(c) comparing the nucleic acid base in each position in each sequence to the nucleic acid base at the same position in each of the other sequences,
(d) counting the number of instances in which the nucleic acid bases at the same position in each of the sequences do not match the base at the same position in each of the other sequences, thereby generating Hamming distances (“HDs”) for the respective sequences,
(e) creating a HD distribution from the HD of the respective sequences, and,
(f) calculating from said HD distribution a selected quantile, “Qₓ”, wherein x is an integer from 1 to 20, to obtain a HD value which divides the HD distribution into x % below it and (100-x %) above it,
(g) determining a value at which the sensitivity and specificity are maximized, thereby selecting a cutoff value C,
(h) comparing said HD value of step (f) to said cutoff value C and determining if said HD value is the same as, higher than, or lower than, said cutoff value C, and
(i) determining whether said subject has clinical symptoms of AIDS, wherein:
when said HD value of step (f) is higher than said cutoff value C, said subject has a chronic HIV infection,
when said subject has one or more clinical symptoms of AIDS, said subject has a late stage chronic infection regardless of said HD value, and
when said HD value of step (f) is equal to or lower than said cutoff value C and the subject does not have one or more clinical symptoms of AIDS, said subject has an incident infection.

29. The method of claim 28, wherein said one or more clinical symptom of AIDS is a low CD₄+ T cell count.

30. The method of claim 29, wherein said low CD₄+ T cell count is a count of less than 200 CD₄+ T cells per microliter.

31. The method of claim 28, wherein x is an integer between 1 and 15.

32. The method of claim 28, wherein x is an integer between 1 and 10.

33. The method of claim 28, wherein x is 10.

34. The method of claim 28, wherein the HIV is HIV-1.

35. The method of claim 28, wherein the sequences of nucleic acid bases of a selected HIV gene from the plurality of HIV virions from said individual are from 50 or more HIV virions from said individual.

36. The method of claim 28, wherein the sequences of nucleic acid bases of a selected HIV gene from the plurality of HIV virions from said individual are from 1,000 or more HIV virions from said individual.

37. The method of claim 28, wherein said HIV gene is selected from the group consisting of env, pol, nef, and gag.

38. The method of claim 28, wherein said HIV gene is env.

39. The method of claim 28, wherein said HIV is HIV-1.

40. The method of claim 28, wherein said nucleic acid sequences are about 500 nucleotide bases in length.

41. The method of claim 28, wherein said nucleic acid sequences about 1000 nucleotide bases in length.

42. The method of claim 28, wherein said nucleic acid sequences about 2000 nucleotide bases in length.

43. The method of claim 28, wherein said nucleic acid sequences are about the length of the selected HIV gene.

44. A computer-implemented method of determining a cutoff value for use in distinguishing, with a high degree of sensitivity and specificity, incident infections of human immunodeficiency virus (“HIV”) from a chronic infection, said method comprising:
(a) obtaining sequences of at least about 500 contiguous nucleic acid bases of a selected portion of a selected HIV gene or of the entire selected HIV gene from a plurality of HIV virions from samples from a plurality of individuals known or determined to have incident or chronic HIV infections at the time the samples were taken, keeping track of which sequences are from persons classified as having an incident infection and which sequences are from persons classified as having chronic infections,
(b) for each sample, aligning said sequences of contiguous nucleic acid bases of said portion of said selected HIV gene to permit comparing nucleic acid bases present at the same positions in each sequence,
(c) for each sample, comparing the nucleic acid base in each position in each sequence to the nucleic acid base at the same position in each of the other sequences,
(d) for each sample, counting the number of instances in which the nucleic acid bases at the same position in each of the sequences do not match the base at the same position in each of the other sequences, thereby generating Hamming distances (“HDs”) for the respective sequences,
(e) for each sample, creating a HD distribution from the HD of the respective sequences for the sample, thereby creating a plurality of HD distributions,
(f) calculating for each of the plurality of HD distributions a selected quantile, “Qₓ”, wherein x is an integer from 1 to 25, to obtain a HD value which divides the HD distributions into x % below it and (100-x %) above it, to create a plurality of Qₓ values, which Qₓ values have a distribution,
(g) determining from the distribution of Qₓ values a value at which the sensitivity and specificity are maximized, thereby selecting said cutoff value C.

45. The method of claim 44, wherein x is an integer between 1 and 10.

46. The method of claim 44, wherein x is 10.

47. The method of claim 44, wherein the HIV is HIV-1.
